(19) United States
(12) Patent Application Publication
(10) Pub. No.: US 2017/0113144 A1
(43) Pub. Date: Apr. 27, 2017

(54) Online Game for Portfolio Management Driven by Real World Stock Market Using Tournament Bracket Format

(71) Applicants: Gary McDonald, Frisco, TX (US); John H. Clomax, JR., South Orange, NJ (US)

(72) Inventors: Gary McDonald, Frisco, TX (US); John H. Clomax, JR., South Orange, NJ (US)

(21) Appl. No.: 14/550,310

(22) Filed: Nov. 21, 2014

(51) Int. Cl. A63F 13/795; A63F 13/46; A63F 13/792; A63F 13/35

(52) U.S. Cl. CPC A63F 13/795; A63F 13/35; A63F 13/46; A63F 13/792

(57) ABSTRACT

An online, virtual stock market game whereby players compete in a tournament bracket-like, elimination competition by creating and managing virtual portfolios comprising real-world common financial investments, likely common stocks. An equal amount of virtual funds are originally provided to the participants. Purchasing shares at the market price, from other players and in multi-Player swaps of assets and valuing the same at predetermined periodic times intervals, players compete head to head to maximize their portfolio values, based on a verifiable market, for example, the New York Stock Exchange. The game progresses with winners of the brackets moving on to play against other winners with the “losers” going to a loser bracket where they continue in the portfolio building competition. All participants are competing for actual cash prizes or merchandise held within a virtual warehouse until actual distribution. The garnering of prizes is based on rules set by the game operators.

### FIELD OF THE INVENTION

The present invention relates to an online, virtual stock market game, whereby players compete against one another in a tournament bracket competition by creating and managing portfolios comprising real-world stocks. An equal amount of virtual funds are originally provided to the participants. While the game does not require players to purchase actual shares of stocks, the game is driven by the value of stocks on the New York Stock Exchange, in the same manner that a fantasy sports league relies on real statistics. The game progresses with winners of the brackets moving on to play against other winners with the “losers” going to a loser bracket where they continue in the competition. All participants are competing for actual cash prizes and/or merchandise held within a virtual warehouse until actual distribution. The game is intended to be fun through its competition in the financial world, will expose the participants to financial strategies and to new and existing products in the warehouse, and will provide advertisers with opportunities for marketing their goods, services and enhancement of their goodwill. The operators of the game are expected to collect entry fees from participants, advertising fees from product and service providers, fees for “naming” rights for episodes or editions of the games or the brackets, etc., and to “run” the game and resolve issues, if they arise. It is an aspect of the present invention that the competition be substantially based on a computer, mobile phone, lap top, etc., with all participants connected via the internet to the website of the operators.

### BACKGROUND OF THE INVENTION AND DISCLOSURE

The present invention discloses an online virtual stock market competition, hereinafter often referred to as a game which allows players to be funded with initial amounts of virtual currency and for them to create and manage a stock portfolio, primarily based on the New York Stock Exchange listed entities (although other financial markets and products can be used with the game, too). The portfolio, —as one would do in real life with an actual stock portfolio—is “built” and the object is to maximize one's profit on the virtual funding. Thus competitors/participants will compete against one another in hopes of achieving the greatest returns on their compiled portfolios, which are not static, but, rather, over time, can be changed by the virtual buying and selling and transfer of the underlying public equities or financial instruments, just as traders currently seek to increase their real portfolio in the real world. The value of each player's equity or financial product/instrument, over time, fluctuates based on the actual market value of the actual equities or instruments/products. The present invention relies upon the public and verifiable markets (NYSE, NASDAQ, ASE, etc. —for ease of illustration the NYSE and public common stocks are used). The value of the actual stocks may change, day by day, and thus the value of the virtual portfolio of a participant may change (if they have that product in their portfolio). Thus, the game is based on real market value and factors, much, in the same manner that fantasy sports leagues and those online games utilize real sporting game statistics to drive the virtual game where players create fictitious teams from real life sport players.

The game of the present invention is designed to preferably join two distinct and mutually exclusive groups: a set of players and a set of companies. In the preferred embodiment of the present invention, the game is designed to attract upwardly mobile, financially knowledgeable, highly motivated, extremely competitive, and well-educated individuals, preferably those representing the top 7% of the U.S. socio-economic population (approximately 19 million people). The set of companies, in the preferred embodiment, is made up of the world's top 100 consumer products and services companies. Preferably, the present invention is designed to attract members of these elite demographics into a social, virtual gaming setting with a monthly membership (payable by the individuals), prizes, services, and goods, offered by the companies, with the individuals being provided, as an incentive to pay and to play, an opportunity to win cash, goods, services and similar prizes. Preferably, the monthly membership fee is low, such as $9.99, allowing players to enter a low-risk, high-reward game setting. However, players can choose to play the present invention, even without payment of a monthly subscription fee. The game operators may decide to open the game to non-paying competitors, if there are openings in the brackets for individual participants/competitors in the game after all paying players have entered. As discussed hereinafter, there are preferably numerous advantages to being a paid player in the game in contrast to a non-paying competitor.

Simultaneously, the present invention preferably provides a social media-like mechanism for consumer products and service companies to market themselves and promote their brands to groups having the preferred demographics of real and “moneyed” consumers. By joining these two groups, high end consumers and product and services providers in the upper range of the US economy, the present invention preferably provides companies advertising their products and services with those individuals in the market most likely to purchase the products or services even if the competitor does not “win” the game nor the associated prize and, in any event, the competitors are likely to discuss among themselves and others the available prizes, goods, and services, all to the advertising and media advantage of the participating and sponsoring companies and their products and services. In addition, the “elite” consumers believed likely to participate in the present online financial game, to establish their intelligence, market prowess, to win cash and prizes, etc., are those most likely to encounter the product, to be able to afford the product, to express a desire for the product, and then, by communicating to others regarding the same, to influence the market trends by promoting those products. The game of the present invention is designed to preferably assist these high-end companies in advertising and promoting their products or services and to recruit elite customer interest, especially in the early stages of the game. Players as they progress from one week to the next still playing the game, especially those which may have been earlier eliminated in their bracket of competition, increasingly covet the goods and services advertised by these companies, especially as they still strive to ultimately become one of the ultimate winners. These participants continue to strive to earn points and virtual profit through the exercise of competitive game play with the end hopefully being an entitlement to the prize under consideration by that participant. Through the game of the present invention, the sponsor companies are able to interact with players and monitor their decision making processes, respond to player questions or concerns, display various products and brands for promotion, and boost brand awareness by educating consumers as to their products.

It is an object of the present invention to provide a virtual game for competitive players relating to the actual price fluctuations of a stock market, i.e., based on real world markets, where the players play against others in their bracket, with winners of the bracket moving on to continue to play anew against other winners and losers in a bracket still maintaining interest as they are still capable of winning prizes, money, goods and services. All the while, some players are gaining advantages to winning and increasing their chances of winning by paying weekly or monthly subscriptions to the operators and, yet, even those who do not pay periodic subscriptions, are interested in continuing to play, even the bracket losers, until the end, a consequence of the availability of prizes, goods and services and the format of the game and its manner of play/rules. The game allows players the opportunity to participate in a competitive game play setting where they are given the opportunity to test their portfolio-building and financial skills. Preferably, the present invention provides a bracket tournament structure for competition in which players compete in a series of rounds (a round may last 5, 4 or 3 weeks), narrowing the field by means of multi-player matchups, with a single winner advancing from each bracket to continue to play against other winners in new brackets. As time continues, week by week, round by round, the winners are narrowed down and the loser's pool, increased by the losers, who, nevertheless, unlike the NCAA Basketball tournament, need not be mere spectators nor losers, but can still gain virtual profits, points, and credit towards obtaining real cash prizes, goods, services, etc.

More preferably, the tournament or bracket structure of the present invention comprises a pyramid bracket structure, where the initial number of competitors in each bracket or level increases, as between one bracket and another. In the preferred embodiment of the present invention, all competitors start with an equal amount of virtual funds. They create their virtual portfolios and thus are stored and secured in the operator's databases. Once the game trading begins, the competitors buy, sell, trade, various selected financial products, usually, common stocks, with one another or they can choose to hold their stock(s), as is. After an initial period of time, 5 weeks, some competitors will be profitable, some not, and some more profitable than others. The operator's system will track the profits and losses, the trades, and positions, and rank each participant's profits and losses. After that initial period, the participants are split into tiers based on their relative profitability, with the highest profitability participants going on in future weeks or time to compete against one another (in a small group) and the next most profitable group of participants playing against one another in a larger group, with the lest profitable competitors continuing to play against one another in future weeks, comprising the largest group of competitors. Initially, after the first level of competition, it is expected that there will be five levels, tiers or brackets, with the top performing competitors placed into the “A” bracket having the fewest but initially most successful competitors to date, continuing against one another, the “B” bracket having a larger in number group of competitors continuing on and competing for profitability against one another, a “C” group or bracket with even more competitors against one another for the next time period, a “D” bracket, and a final or “E” bracket with the most competitors continuing on against one another, comprised of those initial competitors who, relatively, made the least amount of profits and/or lost the most money, with respect to the others. They, continue to play, however, for prizes, cash, goods and services.

As time passes and the end of the new period ends (5, 4 or 3 week intervals), more profitable players/competitors will rise in their bracket and less profitable competitors will be ranked below others in their bracket. The highest profitability competitors in each bracket survive and play against the other highest profitability competitors in the other brackets, with the less profitable competitors being out of the bracket tournament but continuing to seek to increase their portfolio, as the end of the game approaches (time determines the end of the game, say, for example 36 weeks), against the other competitors among the “losers” in the bracket competitor. Players are able to trade stocks and securities with one another, research stocks through research tools provided by the game of the present invention, and earn game points, with a top percentage of players in the game earning cash and/or prizes. Even the losers, however, in the bracket competition can earn cash, goods and/or services, if, among the other losers (a so-caller losers or “Snake Pit” bracket), they create a portfolio with the most value.

### A Description of the Unique Psychosocial Aspects of the Invention

The invention uses several psychosocial techniques to attract, engage, encourage, motivate and subsequently reward a select social economic demographic that is, or represents, the top 7% of the U.S. social economic population, approximately 19 million people. Selling to this demographic first treats them as early adapters as they infect and influence those in lower socio-economics levels to aspire or covet. The early adapters influence can be contagious and drive the others.

To attract this select demographic, the focus of the invention is on a proxy (fantasy) world emulating the hardcore fast paced environment of high stakes investing, Wall Street simulated trading and the associated interpersonal relationships. Although a fantasy construct, players are exposed to an environment reminiscent to that of everyday high stakes investing and securities trading with commensurate cash, merchandise and services rewards available to the “winners.” The skill sets required to experience any level of success playing this Game are high and are concentrated more particularly in the target demographic than they would be in the bottom 93% of the U.S. social economic demographic. As in the real world model for this invention, enrollment into this world is restricted and limited. Only 184,755 participants are expected to be able to compete at any one time. Of course, other editions can be simultaneously or sequentially played. Also representing a microcosm of American social economic society, these “elite” individual players are subject to varying levels of competition, throughout the invention's fantasy tournament structure, reminiscent of a pyramid structure with the least amount (in terms of competitors) of competition in the top tier of the pyramid (0.4% of the participants (729) compete in this tier); the 2^{nd} tier will have slightly increased numbers of competitors than the top tier and it will involve 2.2% of the 184,755 participants; the 3^{rd} tier of the pyramid is very numerically competitive compared to the top two tiers, 8.5% of the total participants are assigned this competitive tier; while those assigned to the 4th tier of the pyramid in terms of numbers of competitors see their opportunities to succeed in the tournament diminish somewhat when compared to those assigned to the 3^{rd} tier and most significantly when viewed with those competing in the top two tiers, 25.3% of the total participants make up this rung in the pyramid; the 5^{th} tier of the pyramid is relatively supremely competitive, in terms of numbers of participants, as a proxy for the majority of American society, 63.7% of the 184,755 players (117,649) compete with one another to claim a single opportunity to win the tournament's cash grand prizes; and, finally, the bottom tier is by far the largest because before the Game will end 99.9973% of all of the participants, 184,750 will be placed in this bottom tier as a result of “losing” in their quest for the 5 coveted winner designations awarded by the tournament to those most skilled to survive their tiered competitions.

Having “failed” to “win” the tournament component of the competition, every participant is still offered a chance at “redemption,” a second chance to compete to win cash grand prize money or items and/or a prominent and desirable consumer product and/or service. Contrasting the unlikely prospect that any of the participants felt they could “win” the tournament, the prospect that a participant now in the bottom tier “will win” something of value, 6 of 7, 85% or 157,042 of the 184,750 participants in the bottom tier, is now perceived to be “highly likely.” Consumer products ranging from exotic cars, family cars, sports equipment (summer, winter, water and health), televisions, mobile phones, home and garden equipment, computers, high-end jewelry, etc. and consumer services such as exotic vacations, tickets to elite national sport events, Broadway Show packages, etc. are provided by the Game operators and participating consumer products and services companies. The invention, at this phase, represents the opportunity for such a high rate of ultimate success of acquisition of a “winning item” that the psychosocial attitudes of those in the bottom tier transforms into a group of players incentivized by the desire for the goods and services offered by the Game sponsors and advertisers that can be earned through the exercise of some competitive, yet reasonable, effort on their part. The effort is reasonable giving participants a very high degree of confidence of succeeding in the acquisition of their targeted item. This scenario causes the participants to fantasize and imagine the planned uses for the coveted items, even recruiting peers, family, friends and neighbors into the process of “hopeful” thinking. This mindset sets the stage for the consumer product and services companies sponsoring the Game to communicate intricate and detailed product and brand awareness information that is ritualistically shared by the competitive participants, seeking to harvest the psychosocial benefits that this information offers, so-called “social currency,” with all of the members of their social universe (statistically the average Facebook user has 350 friends, but a minimum of 74 individuals each) thereby enlisting the powers of “word of mouth” promotion for the sponsoring consumer products and services companies allowing the effective and cogent delivery of each sponsors unique product and branding information to likely at least (184,750×74) 13.7 million people. Companies need to know what makes social media so potent: its ability to amplify word-of-mouth effects . . . —2012 McKinsey & Co. media study (by Roxane Divol, David Edelman, and Hugo Sarrazin).

### Game Duration, Pace and Player Progression

A unique feature of the present invention is the contrived pace and momentum of the Game. The Game is uniquely played over a 9-month period, allowing for natural seasonal fluctuations in the real world equities markets to take effect and be exploited by the most savvy and calculating of the players. Yet the tournament arrangement, which demands that optimal performance be timed to specific time-spaced points in the Game, is such that player performance must peak at the opportune time to advance the player through the prescribed phases of the Game. For example, the Game, which is preferably played over a 36-week period, is divided into 9 rounds, each with durations ranging from 3, 4 and 5 weeks.

Preferably, there are a total of 9 competitive rounds:

One 5 week Qualification (Placement) Round will desirably be used to determine the player's individual placing in the pyramid tournament structure. Seven Elimination Rounds (three 5 week, one 4 week and three 3 week rounds) to determine the individual bracket winners and ultimately the Ultimate Bracket Winner (a cash prize winner). Then, one 3 week Finals Round is contemplated to determine the Grand Prize cash winners from among the top 20 performing portfolios in comparison to and against the Ultimate Bracket Winner of the brackets. The Ultimate Bracket Winner alone determines the “rules” of the final “showdown” or round 9 and may also determine, in the preferred embodiment of the inventive Game, which players are invited to participate in the final competitive showdown. These incorporate an important reliance on the Games' social aspects, which will invite collaborations, collusions, and reprisals for wrongs (perceived or actual) that may have been done earlier in the Game, etc.

Rounds 1, 2, 3 and 4 are each intended to be 5 weeks long. This gives players with more long-term outlooks an opportunity to employ different investment strategies that can only be effective when given a significant amount of time to develop. Although the early rounds involve more players in the aggregate, the more time to employ select investment strategies actually benefits a certain set of investment tools over others. Round 5 is 4 weeks long. It is the only round that is 4 weeks long and it acts as an introduction to the next or coming challenge to the investment strategies that were so successfully employed in the earlier extended rounds. Strategies that favored shorter duration investment approaches are now favored over the longer extended strategies because the round may end before the extended strategies can realize their maximum potential while the shorter duration strategies may be consummated one or more times before the round concludes, thereby allowing players employing this strategy to maximize portfolio returns just prior to the end of the round. Rounds 6, 7, 8 and the Finals Round (9) are all intended to be three weeks long. As the number of competing players diminishes, the pace of the Game picks up significantly as rounds end in three weeks rather than the initial five weeks to which players may have become accustomed. Long-term investment policies will typically be less or least effective in these shorter rounds then a proactive short-term strategy unless that tactic employs protecting a significant portfolio appreciation from deterioration. Otherwise, short-term investment options will carry the day over long-term options, completely turning the tables on the remaining players whose earlier and/or current success in the Game may be ascribed to a generous dose of long-term investment strategies. Players able to quickly adopt alternative strategies and/or protect a significant value appreciation already acquired must work under this new set of timing constraints to be successful. Thus, long and short-term strategies need to be mastered to be successful in this Game.

### DESCRIPTION OF PRIOR ART

To the Applicants' knowledge, there are a number of prior art “stock market” and online games open to competitors. The “CNBC Million Dollar Challenge Portfolio” game involved active portfolio management and cash prizes. There was neither entry fee nor periodic subscriber fee to keep playing. Thus, there was little compensation to the operators beyond that achieved by having a company's good will associated with and operating the game. In any event, however, the chances of winning by a single competitor/player were extremely low (in a winner take all model). And, unlike the present invention, there was no ability for securities trading among players, and it comprised a very short game play window of weeks. The ability to trade stocks and manage a portfolio over a long time frame (i.e., it is envisioned that the present game can be best offered over a 9 month period) is highly desirable as it is more realistic to actual gains and losses and less subject to a single “play” of luck by an individual. Winning over time is considered to require more financial acumen and less luck. The present invention is intended to be played over many weeks.

In the “Wall Street Pros vs. Main Street Joes” game, the competitors were connected to a respected financial digital media company. This game allowed players to compete against Wall Street professionals. However, it, too, employed a single winner take all strategy, and there was no game progression. Even if the top x competitors were declared winners or y % winners, there was little direct competition among weekly winners in a bracket; best survive to play again, condition. The present invention is considered far superior and more effectively captures the excitement of winners moving on to play other winners (like the NCAA basketball tournament) and also encourages and rewards long term portfolio management over short term “luck” with one or more stock picks. The bracket system of the present invention allows players to compete in small groups and advance in successive rounds while the field of competition narrows but the level of competition increases as the players move on. This continually increases a player's odds at winning the game, the further along he or she advances, while still having the competition grow increasingly difficult as the survivors are playing other survivors (winners keep playing, losers drop into the Snake Pit). This is believed to be a truer test of business acumen and is also intended to maintain increased interest among the on-going winners or survivors and even interest among the observing losers (who can still win prizes, money, goods and services).

The games “Wall Street Magnate” and “Market Watch Virtual Stock Exchange” are games which both provide poor game mechanics and focus specifically on education. They do not allow for virtual market trading based on realistic stock trading and portfolio management of the present invention. They have no cash prizes, and there is a limited game competition, head to head, and bracket participants against one another. That experience is not believed to be nearly as interesting to consumers as the present invention.

Next, “Wall Street Survivor” was one of the first online trading games for players, but had little set structure, which allowed players to play at their own pace. This removed the highly competitive and quick-thinking nature of the present invention, which requires players to continually monitor their portfolio, sometimes to act with others on the opposite side of a trade, and to act quickly to buy, sell, and trade stocks and financial instruments. The present invention more nearly tracks real world financial portfolio management and the buying, trading, and holding of securities, even among competitors, often acting as market makers.

Finally, there is the “FA Folio” Fantasy Stockbroker game, which comprises a complicated gameplay, no cash prizes, and no social aspect to the game (i.e., no interaction between players). That interaction—the trading of stocks between active players in the game—is an extremely important and innovative feature of the present invention.

### SUMMARY OF THE INVENTION

The present invention presents an online virtual stock market game in a bracket or tournament-like format (with winners of the brackets moving on to continue to compete against other bracket winners) which allows players to create and manage a stock portfolio and compete against one another in hopes of achieving the greatest portfolio return and thereby test their financial, market-maker, and stock analytical skills. Each player is initially provided with the same amount of virtual funds in their account. They then set out to buy or sell (selling short is surely a strategy to be pursued, just as in the real market world) equities or other available financial products (hereinafter for ease of illustration, the game will be described with respect to common stock of a limited number of entities listed on the NYSE, it being clearly understood that other financial products can be tracked by the operators and the competitors). The value of each player's portfolio is based on the actual market value of their retained cash, accrued, if any dividends, and, primarily, “owned” stocks. Pegging the positions in the competitors portfolio to that of the close of market of the NYSE on a daily basis is uniform and “fair” and allows the virtual game to track the real world values of the underlying assets, much in the same manner that fantasy sports leagues comprised of teams cobbled together of non-teammates, utilize real statistics to drive the game where the virtual players compile fictitious teams by trading the players.

Preferably, the present invention provides a bracket tournament structure for competition in which players compete in a series of rounds, narrowing the field by means of multi-player matchups, with a single winner advancing from each bracket. More preferably, the tournament structure of the present invention comprises a pyramid bracket structure, where the initial number of competitors in each level or tier increases as the width of the pyramid widens, i.e., the largest bracket comprises the most number of players. Players are able to trade stocks and securities with one another, research stocks through research tools provided by the game of the present invention, and earn game points, with a top percentage of players in the game earning cash prizes or the best goods/services.

In the preferred embodiment of the present invention, there are a total of nine competitive rounds (36 weeks, divided into four 5 week competitive rounds, one 4 week competitive round, and four 3 week competitive rounds), and preferably there are a total of 184,755 players initially competing and provided with their virtual funding. The Game preferably will span 9 months or 36 weeks and consists of 9 rounds of competition. The first round of competition is known as the Qualification (Placement) Round and it has a preferred duration of 5 weeks. Then, there are 7 rounds of head to head tournament-like competition, at the end of which a Top Bracket Winner will be determined and awarded one of the Games two cash grand prizes. Three of those seven rounds are 5 weeks of duration, one round is four weeks long, and three rounds are three weeks in duration respectively. The final round (Round 9) is three weeks in duration and is the climatic period for the Game. The Finals Round pits the Ultimate Bracket Winner from the bracket tournament against the top 20 players with the highest portfolio returns at that point in the Game (these players will come prominently from the losers of the competitive weeks, known collectively as “the Snake Pit”). These 21 players then compete for the final cash grand prize. Also during this final round, all of the merchandise and service prizes accumulated for the Game by the operators from sponsors, advertisers, etc. are distributed to the Snake Pit players, accordingly. The duration of this final period is 3 weeks.

After the initial five week initial qualifying or placement round (Round 1) when all of the participants are pitted against each other in an effort to produce the highest investment returns (in dollars or other currency) to their portfolios, all 184,755 players are ranked and placed in their brackets accordingly: The top tier or “A” bracket is assigned to the top 729 ranked players, the second tier or “B” bracket is assigned the next 4,096 ranked players, the third tier or “C” bracket is assigned the next 15,625 ranked players, the fourth tier or “D” bracket is assigned the next 46,656 ranked players, the fifth tier or “E” bracket is assigned the next 117,649 ranked players and the base of the pyramid, the “F” bracket, is labeled the “Snake Pit” and it is where all of the players who lose their initial head to head portfolio challenges (after the preliminary or qualifying round) continue to compete in the Game, this time primarily for merchandise, prizes and possibly cash provided primarily by the operators of the Game and the companies advertising in and sponsoring the Game. There are no initial players assigned to the “Snake Pit.”

Appendix A (Page 1) is a Chart showing the numbers of participants/or players in each of the Brackets, including the Snake Pit, and the number of weeks for each bracket competition, along with the percentages of participants/players still “in” the bracket competition and those in the Snake Pit. Page 2 of the Appendix is a brief Summary or overview of the numbers and participants in the various brackets and Snake Pit, as the competitive game disclosed herein progresses, and Page 3 is an illustration of the Great Pyramid showing the number of participant/players originally in each Bracket and the competitive market game.

### BRIEF DESCRIPTION OF THE DRAWINGS, APPENDIX AND DETAILED DESCRIPTION OF ASPECTS OF AND THE DISPLAY SCREENS OF THE ILLUSTRATIVE WEBSITE FOR INTERACTIVE PLAY OF THE INVENTION

FIG. 1 is a schematic view of the pyramidal structure of the present inventive market bracket set-up, showing the number of players/competitors assigned to each bracket and showing, clearly, that the top or “A” bracket of players has the fewest number of participants, while the next bracket “B” has more than that of “A” but less than the number of participants/competitors as in “C.” Clearly the “C” bracket has fewer competitors than those in bracket “D” and bracket “E” is even greater in size than “D” with competitors and participants. As brackets winnow down, by competitive play and passage of weeks and winners being declared and moving on to continue to play against other winners, the losers fall out of the bracket phase of competition and become members of the lowest but largest bracket (initially with no one) but rapidly increasing in size, the so-called, “Snake Pit.”

FIG. 2 is a snap shot of a sample web page showing some details of the present invention, as would appear to a potential player (persons not yet registered as a player). One can see at a glance, the name of the Game, the sponsor, a portal for Welcoming new Participants, which, when entered by suitable log in and registration, will provide Game Rules and examples of play; the top players of the day showing a thumbnail photo, a user name (not likely the real participant's name) and the total portfolio percentage gain for the day. This is the home screen where players are not logged in—this web page is designed to entice people that haven't signed up to play subsequent games, to get a visual representation of the tournament and its competitive spirit; a schematic of the bracket structure of the Game, showing the participants, their portfolio percentage gains, which competitors are still in the Top Brackets and still “in play;” advertising for some of the lower prizes which can change by clicking or automatically by time, depending upon the operator's desire; an advertising/sponsor block, a current market trends and most active, biggest gainers, losers, information section, etc. Also, the bottom banner can be provided with tabs/buttons allowing the user/participant to navigate to other parts of the site, e.g., a Site Map, Contact to the Operators; a button for additional advertising information opportunities, a career button/link for an employment exchange, Privacy Policy information, Legal information, Terms of the Game, an RSS feed button, Ad Choices, payment options, etc.

FIG. 3 is another representative page of the website, showing many of the same features as shown in FIG. 2 with a more detailed look into the 5 brackets; The arrow allows a player/potential player to get specific information regarding that bracket; total number of players per bracket, number of players going head-to-head and the duration of each round displayed in weeks. The sidebar of the webpage will include specific details regarding a players competition; such as the number 1 player and number 20 player. This is important to all players, as the top 20 players at the end of the game will compete against the top bracket player for the grand prize. In addition, players will have visibility as to the ten players ahead of them with higher portfolio values and the ten players behind them with lower portfolio values. In addition, there will be opportunities for advertisers/sponsor to display their logos on each bracket screen.

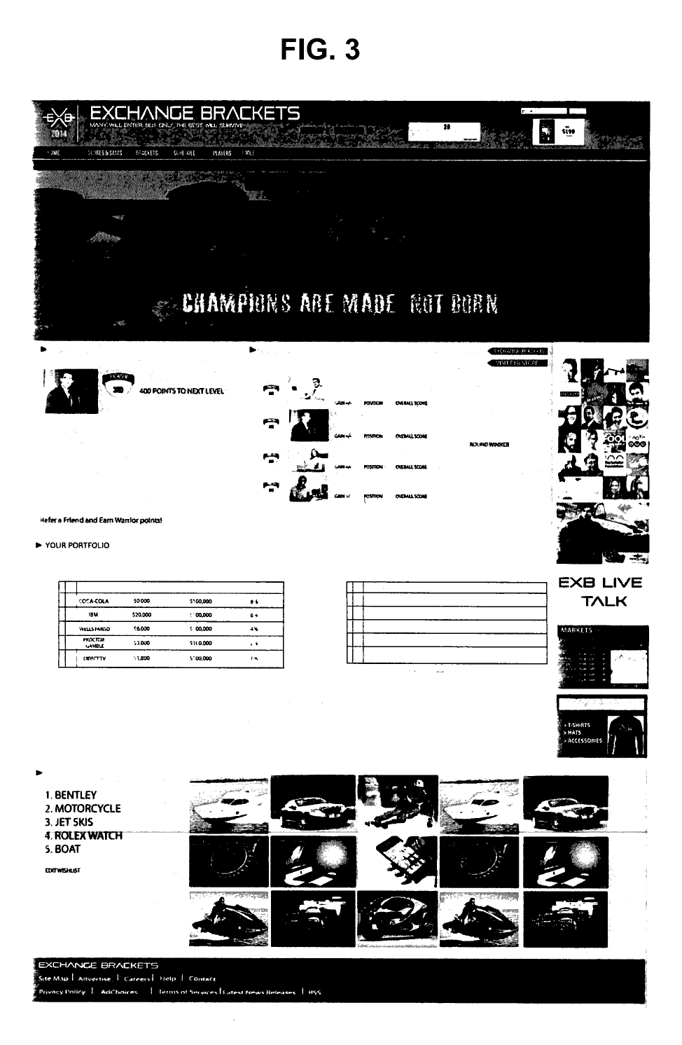

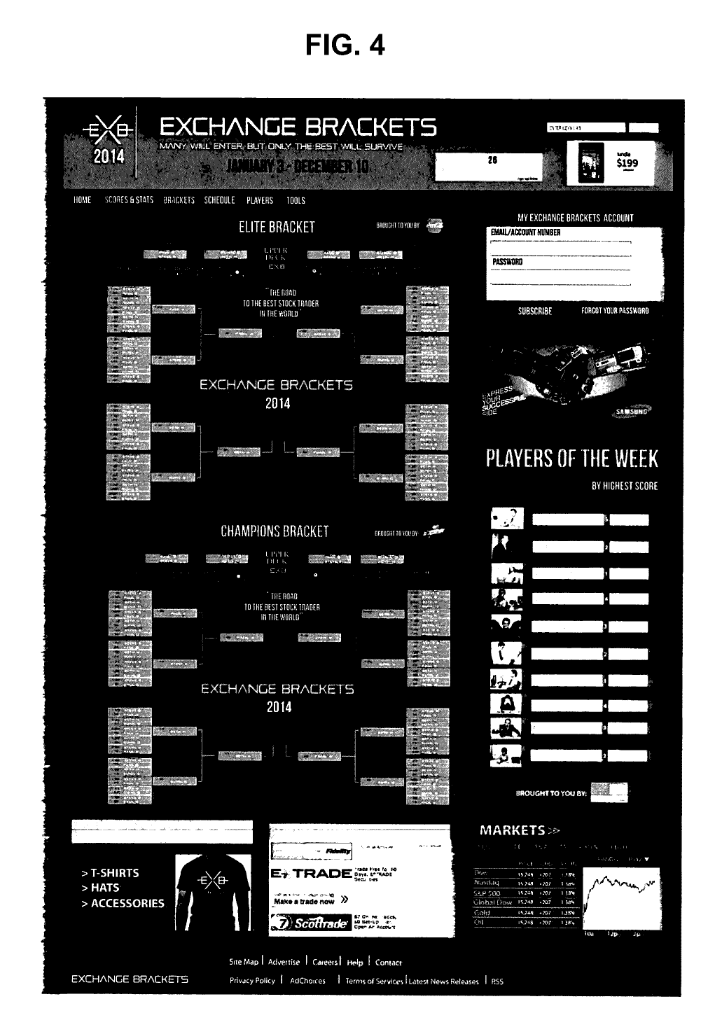

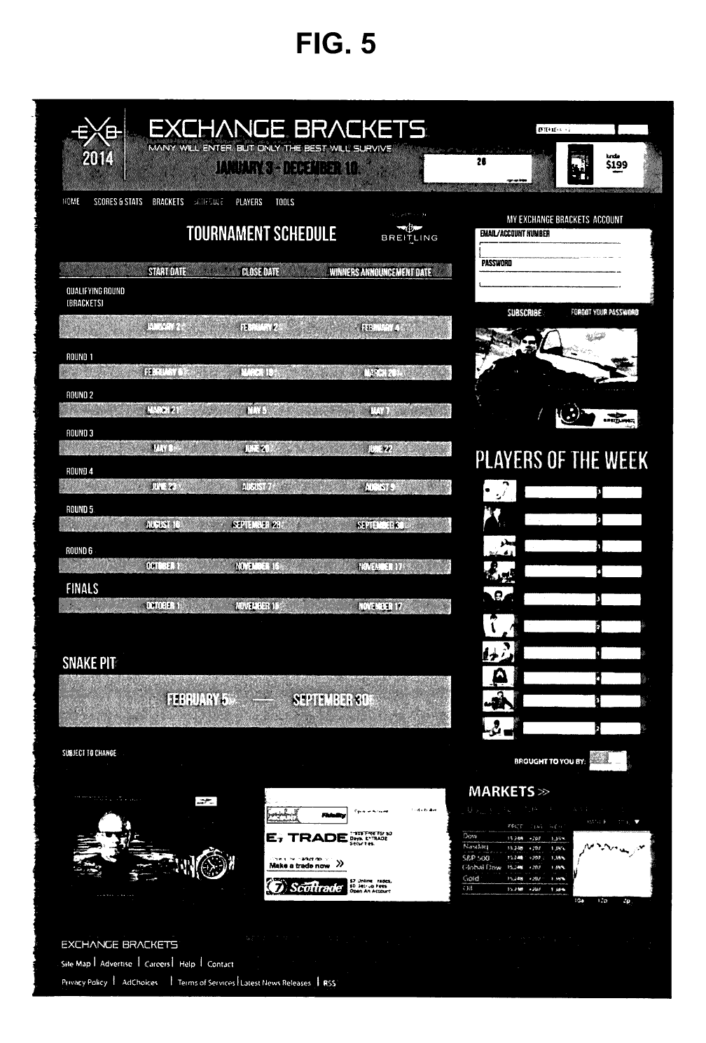

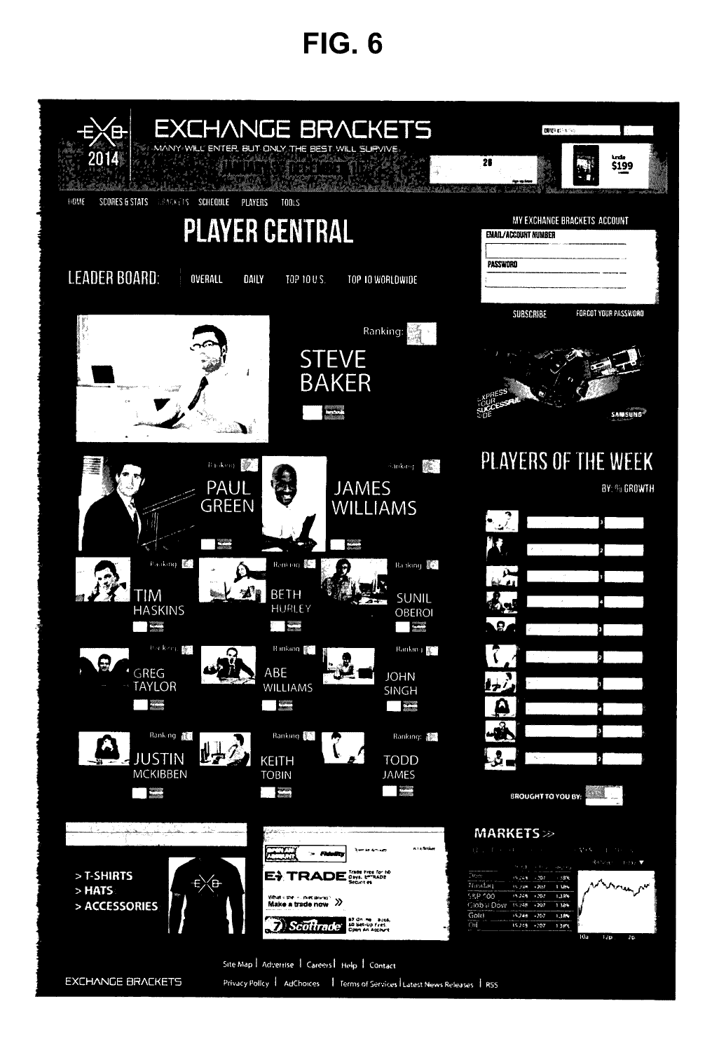

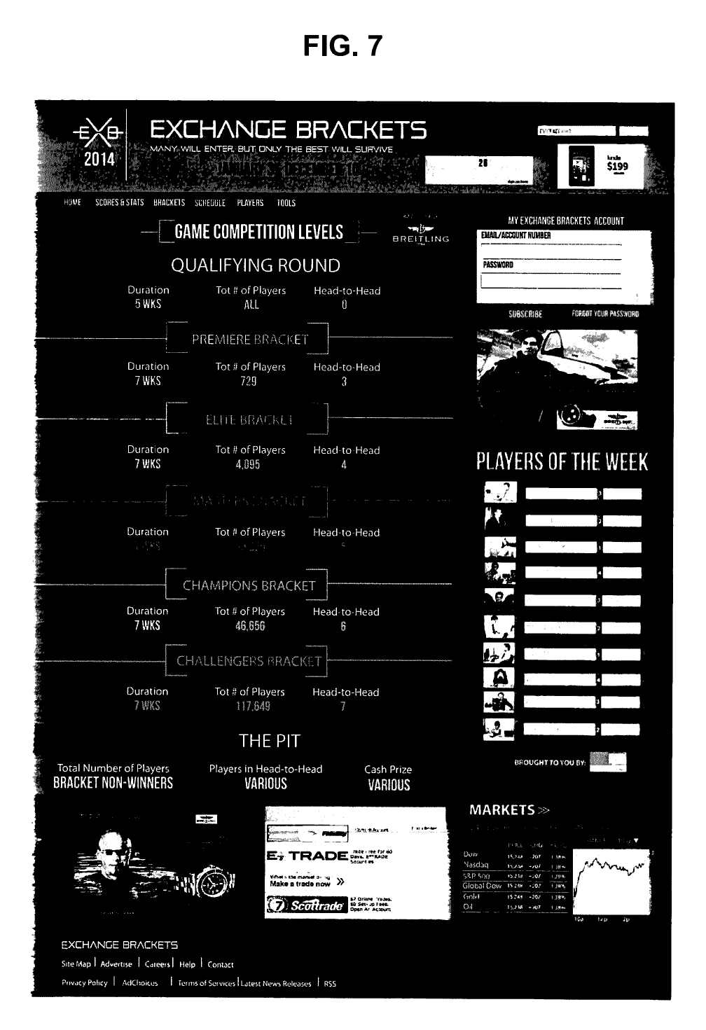

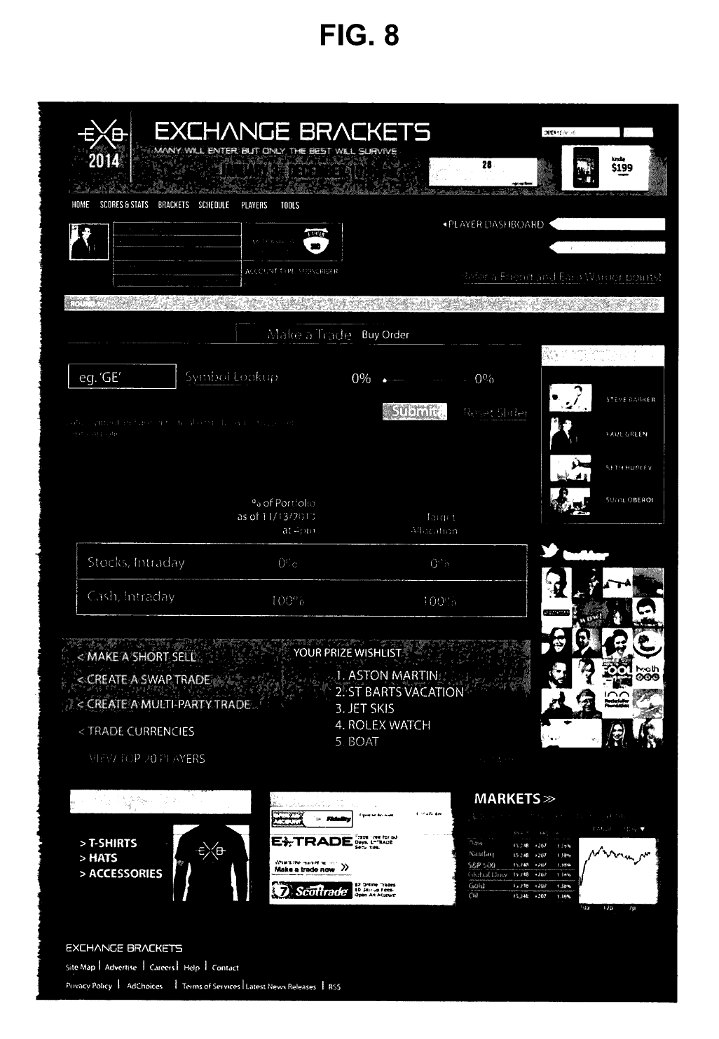

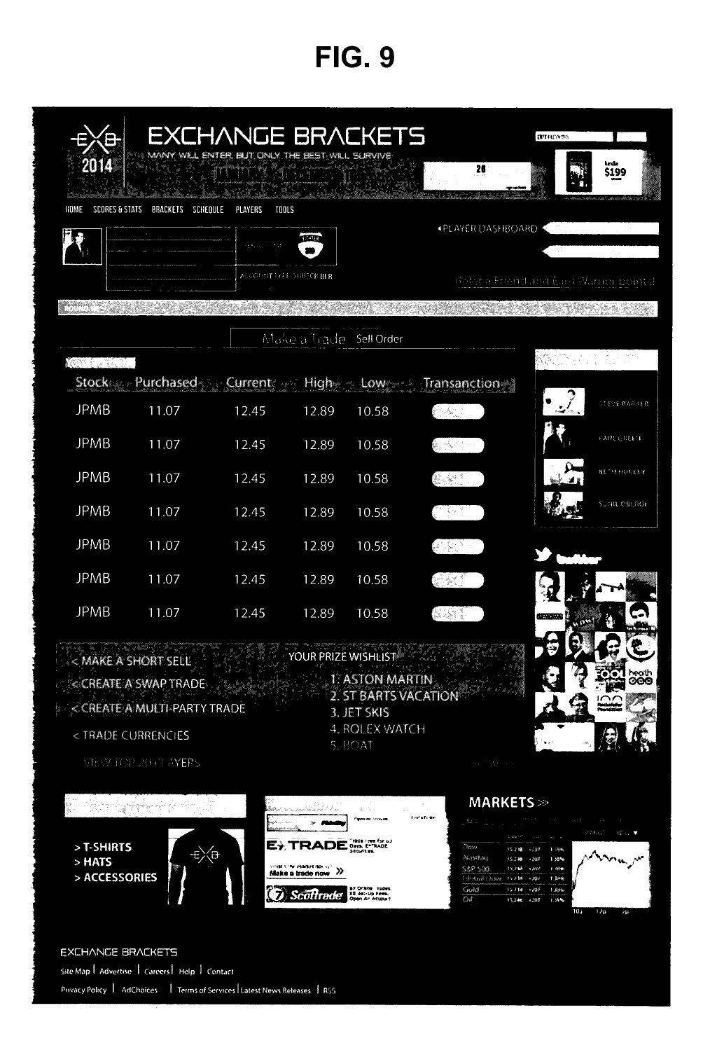

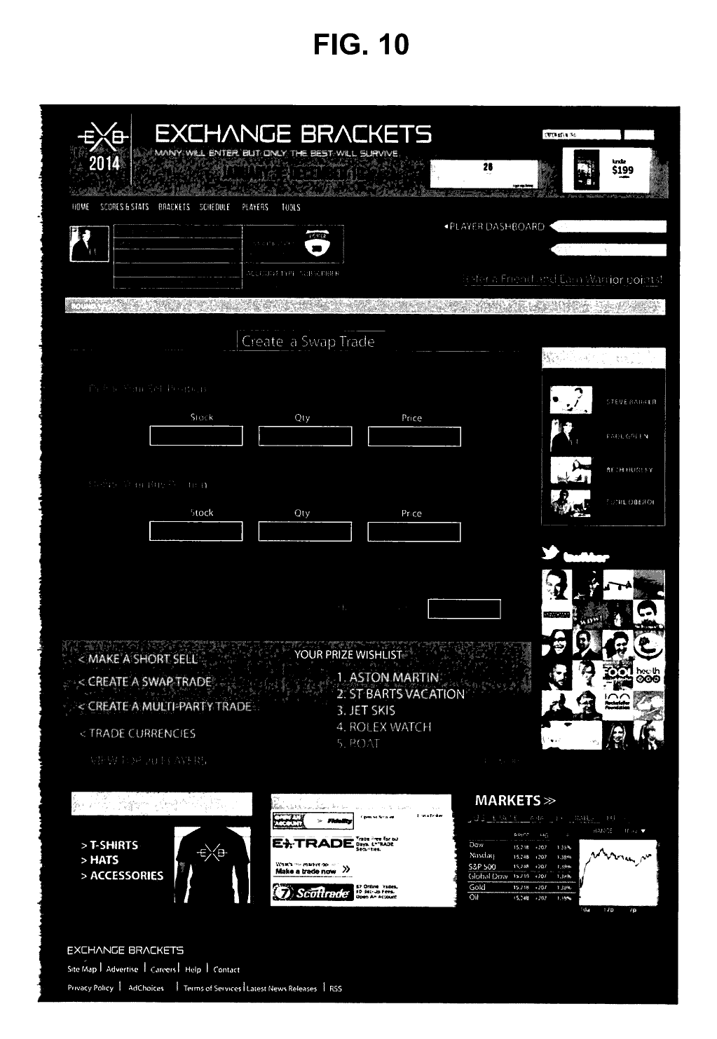

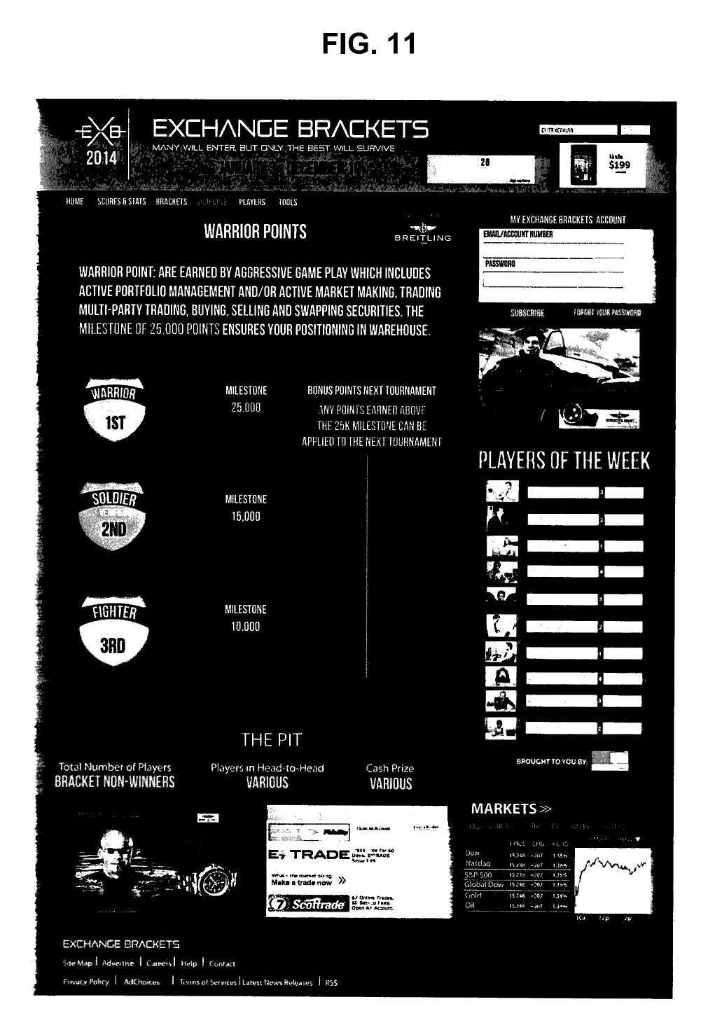

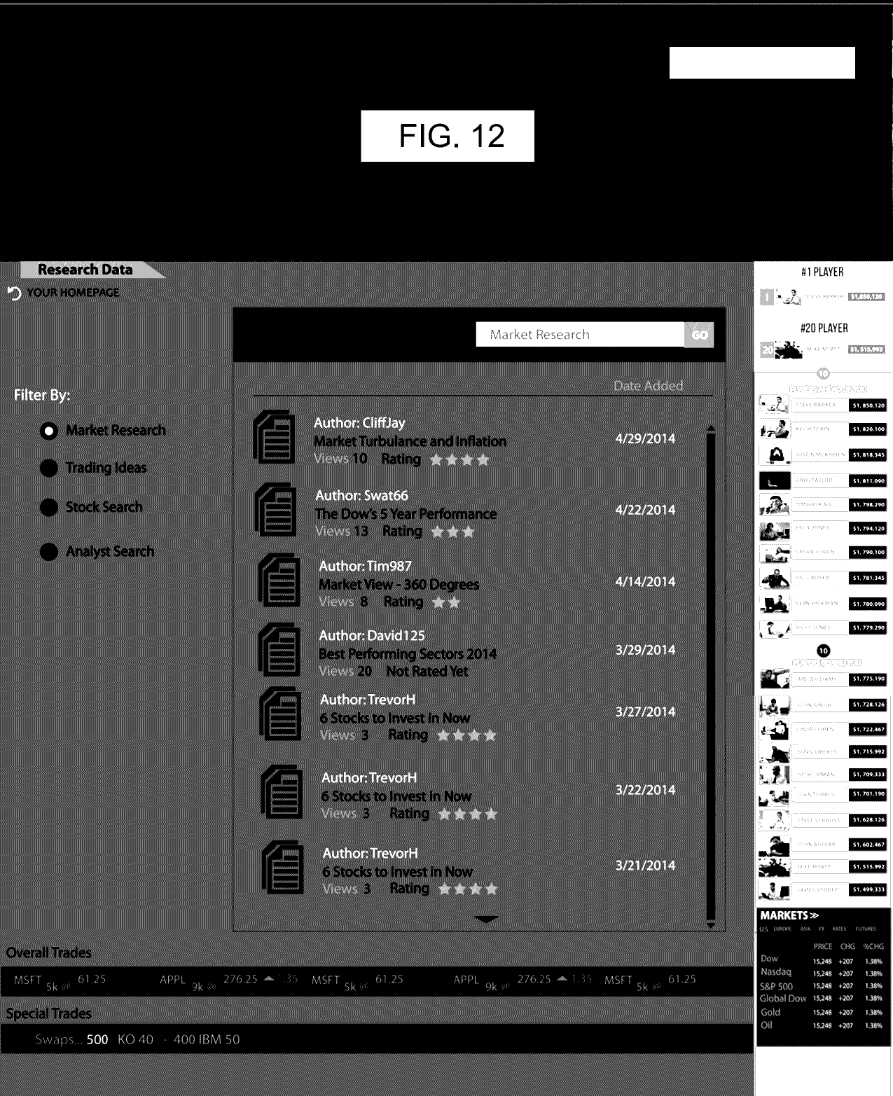

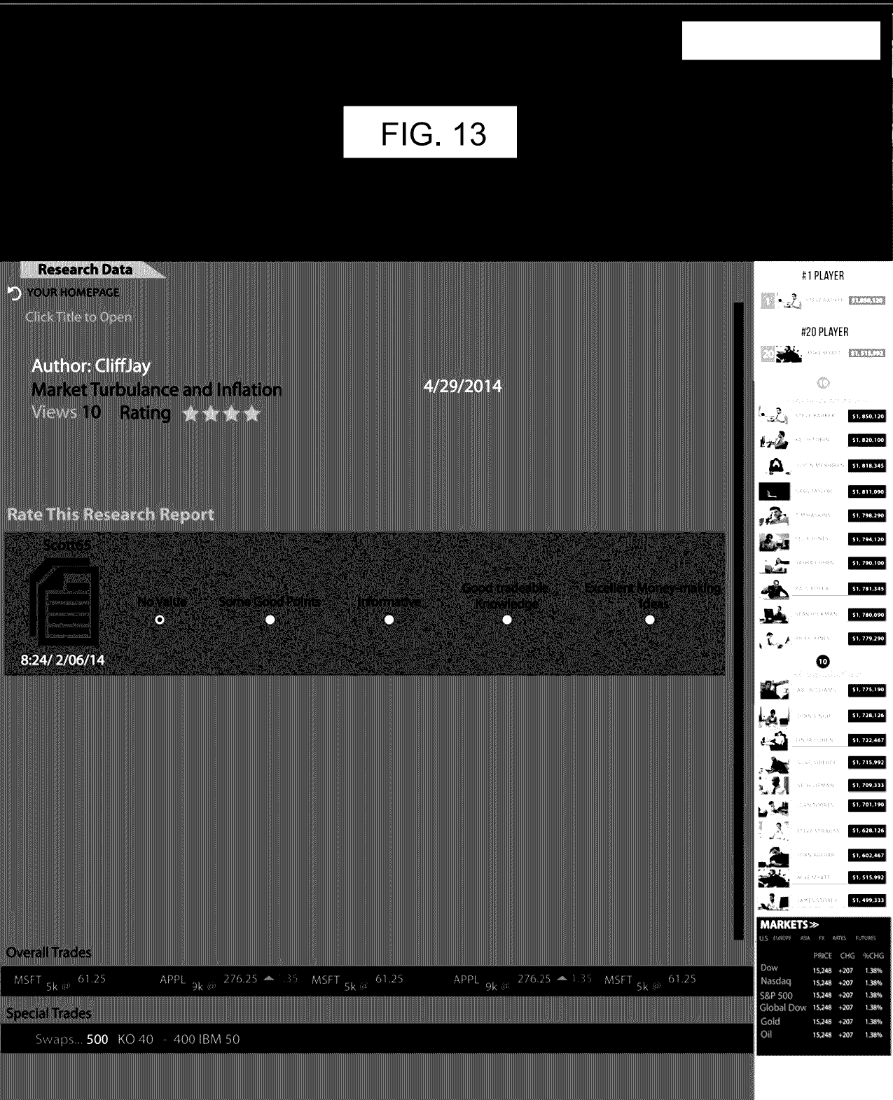

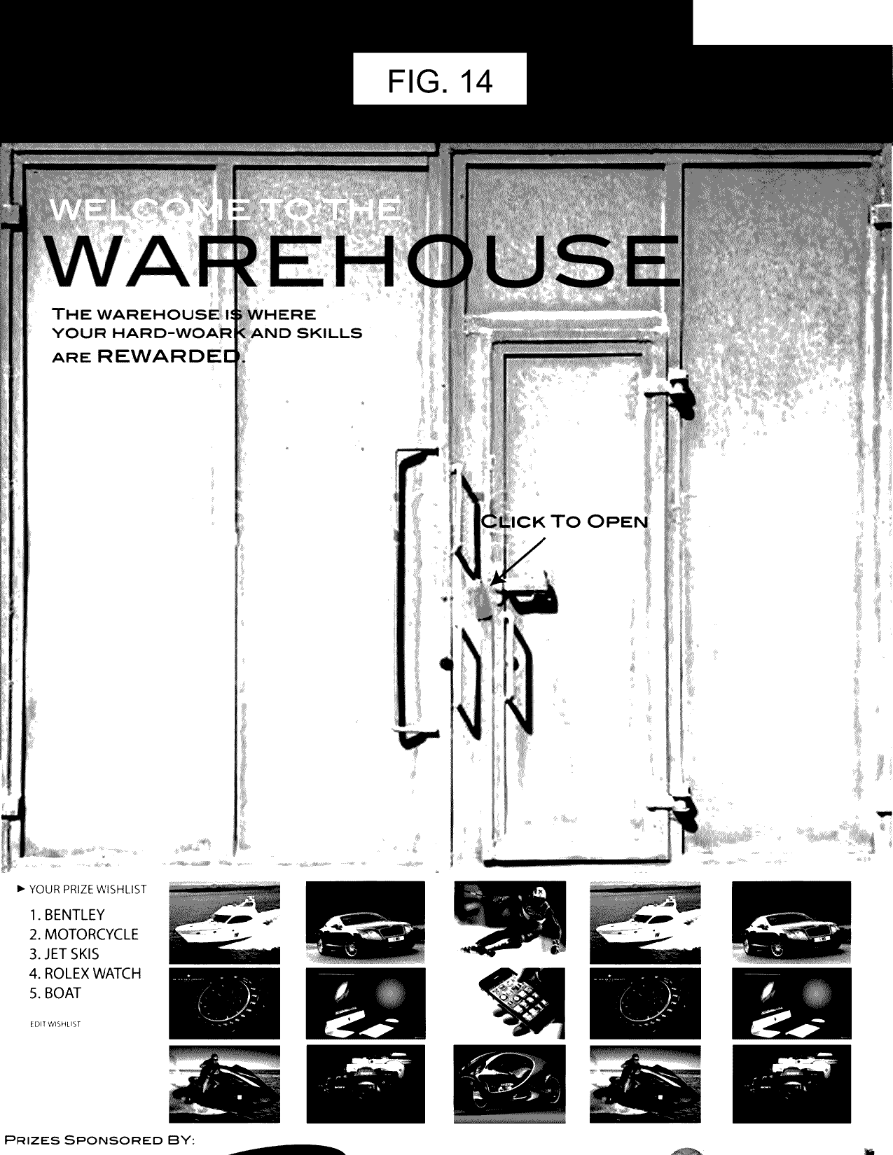

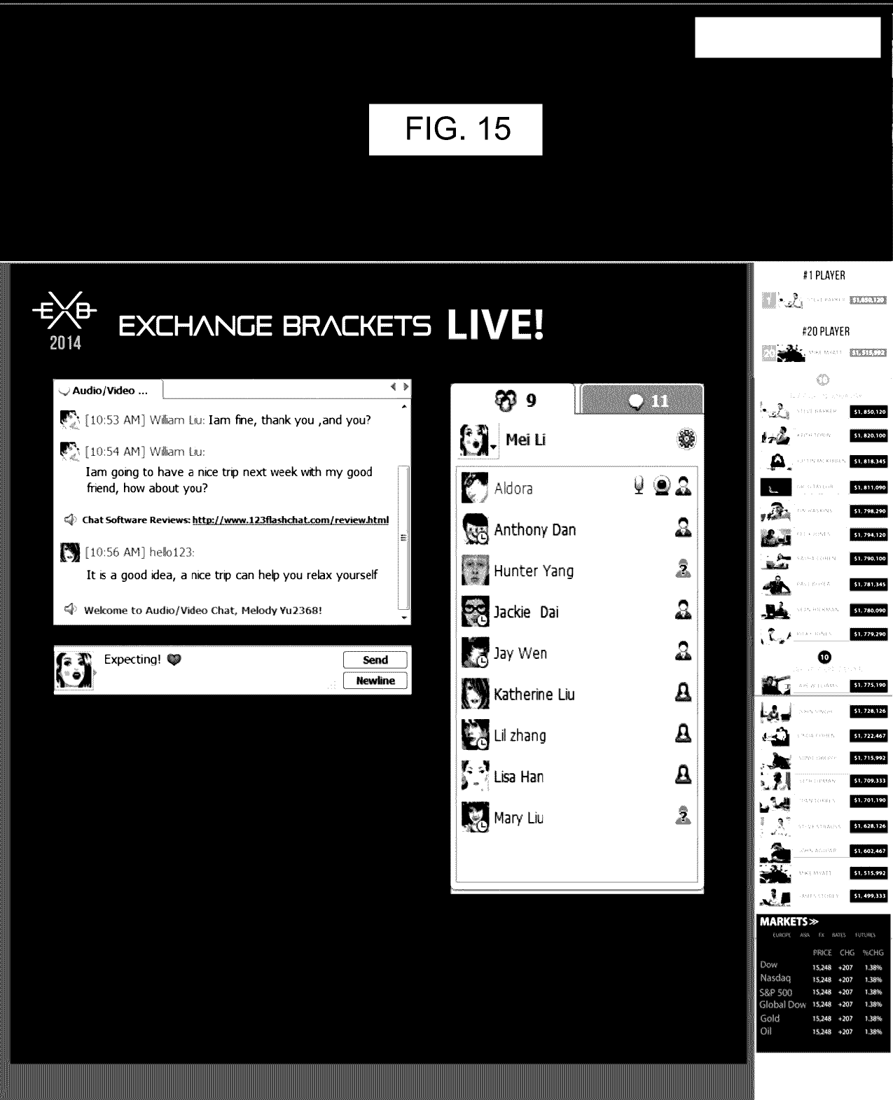

Another representative page of the website (not shown), has many of the same features as shown in FIG. 3 from the perspective or advantage of being an actual player (registered). The sidebar of the webpage will include specific details regarding a players competition; such as the number 1 player and number 20 player. This information is important to all players, as the top 20 players at the end of the game will compete against the top bracket player for the grand prize. In addition, players will have visibility as to the ten players ahead of them with higher portfolio values and the ten players behind them with lower portfolio values. This allows players to get a sense of their immediate competitive surroundings, but are still unaware of which players are the overall leaders.

FIG. 4 is another sample or representative page of the website (dashboard for bracket players only) showing, for example, a players name, city, current bracket being played in, warrior point totals, current portfolio value, available cash on hand and his player status whether a subscriber or non-subscriber. The dashboard will show a quick view of a players performance by listing today's date, todays gains (positive or negative); this page of the website will show, for example, the competitors current portfolio value, portfolio gains (positive/negative). This webpage illustrating and supporting the game of the present invention—and the fields of the page show a proposed transaction screen with options for the user/competitor participant to allow him/her to “Make a Trade” (on the Buy side) i.e., to take some of his original virtual portfolio funds and purchase an equity or financial product or to sell the same after purchase, allowing, too, for short sales, for a swap trade within and among other competitors, for a multiple party trade within the game and its competitors, and to toggle back to the page of the site showing the top players. Lookup provides information when the competitor only knows a name or partial name but not the actual Stock Market Symbol or ticker letters. The webpage also includes a running stock ticker tape that shows overall trades during the day as well as special trades (swaps, multi-party trades) that have been executed. A section of the webpage will have a ‘bracket players’ next round (if they win the current round) start date and duration of that competitive round. Advertisers and sponsors will also have an opportunity to promote their brands in this section as well. The side-bar will be consistent in showing the top performers and competitors in front and back of a player.

FIG. 5 is another representative page of the website, showing many of the same features as shown in FIG. 5 but from the advantage of being a player competing in the ‘snake pit’ only. The sidebar of the webpage will include specific details regarding a players competition; such as the number 1 player and number 20 player. This information is important to all players as the top 20 players at the end of the game will compete against the top bracket player for the grand prize. In addition, players will have visibility as to the ten players ahead of them with higher portfolio values and the ten players behind them with lower portfolio values. This allows players to get a sense of their immediate competitive surroundings, but are still unaware of which of the players are the overall leaders.

FIG. 6 is another representative page of the website, showing a complete list of a players assets, and critical information regarding those assets—called the “Asset List” page; including stock symbol, current price, todays change, today's range, number of shares, per share basis, total basis, total market value and gain or loss. This page is designed to assist players in managing their virtual assets, by giving them a specific look into the performance of their individual assets. The webpage also includes a transaction section as noted in FIG. 4 (Make a market, Swap trade . . . ) Also, under the quick reference portion of the page a player will be able to quickly glance at his/her portfolio holdings summarizing asset name, # of shares and value of those shares. In this same section a player will have the option to quickly view items in their “Watch List.”

FIG. 7 is another representative page of the website, showing many of the same features as shown in FIG. 6 but within this webpage a ‘buy’ transaction can be executed by a player where specific information has to be entered to set the parameters of the trade; setting the number of shares to be purchased, entering stock symbols, setting purchase price (or stop limits, stops, limits or purchases made from the market), and duration of the proposed buy transaction-day order, Good until cancel (GTC) or player to player. Once the parameters of the trade have been set, a player will hit the ‘submit’ button for the trade to be executed by the game. A “review this trade” button can also be provided before the submit button effect the trade. A sell transaction will mimic the same parameters as the buy transaction mentioned in FIG. 7A with the sell button being selected along with the submit button to execute the trade.

FIG. 8 is another representative page of the website, showing many of the same features as shown in FIG. 5 but allows a player to setup his watch-list in hopes of tracking (watching) stocks that he/she believes will be advantageous based on specified target prices set for each. A player sets up the watch-list by entering a stock symbol in the field and a target price associated with that specific stock. Once the player confirms his/her parameters, the stock is added to the personal watch-list, which has a maximum of 10 stocks that can be entered at a time. A ‘red’ or ‘green’ indicator will be shown with each stock showing whether the stock has met the target price set by the player. A red indicator indicates the stock has not met the players target price for the stock, and green indicates the stock has met the players target price. This will help to alert the player to a condition (price) of interest at which the player may then consider a buy, sell, and sell short, swap or multi-party trade. Stocks can be added, edited, reset and removed at any time during the game. The watch-list only serves as a tool for the player to make better informed decisions during the game, and will not have an affect on his/her actual portfolio value or cash positions.

FIG. 9 is a representative page of the Game's website and shows another feature of the same. This page relates to so-called Warrior Points which the competitors can earn by being more aggressive or trading, buying, selling, swapping, multi-party swapping, etc. Even “after market close” and/or pre market trading and swapping may be encouraged. These transactions can result in the accumulation to the competitor(s) of Warrior Points, which relate to the right and standing of the competitors vis a vis one another to obtain the prizes, selected from the Products Warehouse or prizes. Under the condition(s) set by the Operators, a minimum, for example of 25,000 Warrior Points need to be accumulated to ensure that a competitor has access to and is ranked for the various products/prizes in the Products Warehouse of all products/prizes. An aspect of the present invention also relates to accumulating Warrior Points by a competitor for use in a following and new Game. The earning of the points by a player is shown numerically by; what activities need to be accomplished and the number of points earned for that activity, percentage points earned at that point in the game for the said activity and the remaining Warrior Points available for the said activity. The field will encompass a competitor's profile picture along with his/her total Warrior Points earned. The running stock ticker tape will appear in the field as well.

FIG. 10 is a representative page of the website showing many of the same features as shown in FIG. 5—allowing competitors in the Game, independent again of their Bracket or even if within the Snake Pit, to affect a Swap Trade with another competitor. So, for example if the competitor whose Page we are reviewing in this Figure, has 100 shares of CITI valued at $50 per share, and wants to sell the same, he can offer to sell at the market (or a price of his choosing), at the day's close, an open price, etc. (as determined by the operators of the Game) OR he can SWAP the same, to advantage in earning Warrior Points, described hereinafter, if another player is interested, too, in the other side of the transaction. So, for example, if the other player has 1,000 shares of GE and those are trading at $5 per share, then the parties may agree, within the context of the Game to a straight up SWAP. However, if one party's shares are worth more, say CITI is worth $100 per share, then the party swapping GE for CITI may be forced to also provide some cash incentive to make the Swap, say, in this example, $5,000. He may offer less or more and depending upon various conditions, the parties will come to an agreement, all based on the interaction of the web pages and these transaction pages of the interactive website for playing the Game. Once Agreement is reached, the two competitors will have a stated period of time to affect the Swap and when effected the parties' accounts are correspondingly updated and because of the swap nature of the transaction, each will earn Warrior Points. A competitor can hold up to 4 swap trades at a given moment. There will also be a field that indicates Warrior Points earned for making the swap (the creator of the swap) and Warrior Points earned from the actual swap trade (for both players).

FIG. 11 is a representative page of the website showing many of the same features as shown in FIG. 5 but this field displays a review of the market where a number of specific market opportunities are broadcast by various players to the entire gaming population outlining explicit numerical values for bid and offer prices for individual stocks; number of shares and the duration of the transaction.

FIG. 12 is a representative page of the Game's website and shows another feature of the same. This page relates to so-called Research Data, which the competitors (subscribers only) can utilize. Research Data, provided by analysts who may or may not also be players/participants, may also allow for Warrior Points to be earned. The analyst, if not a player/participant, will be awarded cash for reports that garner a high number of views and high rating (depicted by # of stars). Included in this webpage is a search field that permits players to search for specific information on stocks, analysts, sectors . . . a filter that enables information to be deciphered down by analyst search, trading ideas, stock search and market research.

FIG. 13 is a continuation of FIG. 12 and allows players to rate a research report. In this webpage the author of the report is visible along with the name of the report and the current views and ratings are displayed. The ratings are divided into 5 ‘votes,’—where the player inputs his value of the report; no value, some good points, informative, good tradable knowledge or excellent money-making ideas.

FIG. 14 is a representative page of the Game's website and shows another feature of the game known as the “Product Warehouse.” The Product Warehouse is filled with items from the game's sponsor(s)/advertisers. These items are on display and available to the gamers through out the first 33 weeks leading up to their distribution to the winning players. Once all of the players positions in terms of Portfolio Value and consistent with other rules of alignment for products, are calculated by the game's operators—the players will enter the Product Warehouse and pick their prizes according to their positions. This gaming strategy adds two tiers of value to the game—1) high winning percentages for the players who have entered, even if their portfolios were not sufficient to allow them to continue on in the bracketed component of the competition, and 2) exposure and awareness to the sponsor(s)/advertisers' game partners. To distinguish items that are sponsor-purchased from those that are placed in the Game by the invention's operators, the items from sponsor(s)/advertisers' will be “branded” by the sponsor/advertiser such as Apple iPad® or Samsung Galaxy®. If the invention's operators purchased those same items the depiction would be more “generic” such as notebook or smartphone. There will be no more supportive information provided thus encouraging players to focus their attention and product research efforts to those branded items. It also allows for the game to offer merchandise that does not compete with the branded items in the Game while also working to enhance the Game's reputation among potential players (exotic cars, exotic vacations, exceptional jewelry) producing (through word of mouth) a gaming craze among the targeted demographics.

FIG. 15 is a representative page of the Game's website and shows another feature of the same. This page relates to the game's chat room called EXB Live. This page allows players to have a community to banter back and forth amongst each regarding game subjects such as, bragging rights, great or miserable trades or swaps made, comments on the game, players, on the consumer goods offered in the Warehouse, general market related and game discussions, etc. The game operators and players will serve as the content creators (and the operators may also serve to censor the content, where appropriate) to create discussions, dialogue and debates surrounding the gaming competition.

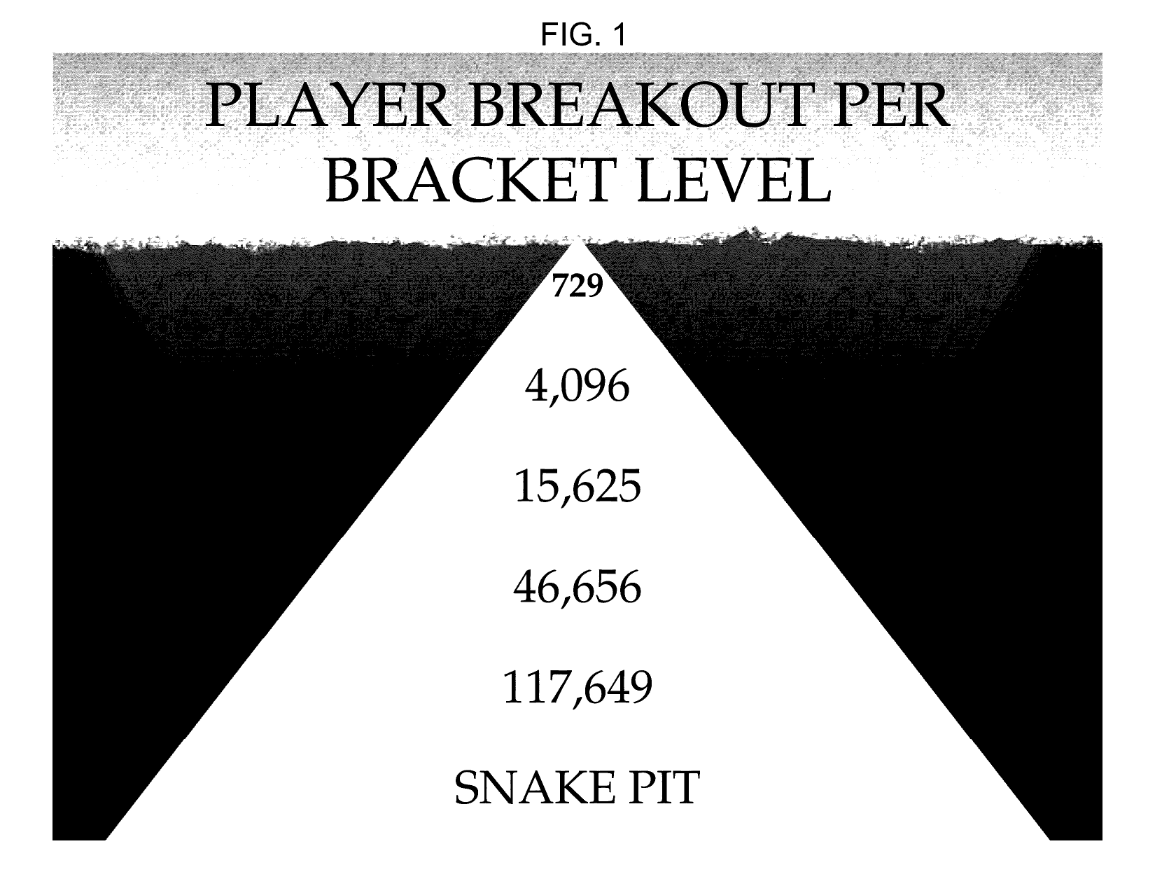

FIGS. 1-15 and the Appendix are depictions of aspects of the Game, a premium prize in the Product Warehouse, the Great Pyramid showing the numbers of Players in various Levels of competition and other aspects of the Game including the database known as the “Product Warehouse Catalogue.” The Product Warehouse is filled with items from the game's sponsor(s)/advertisers and/or the invention's operators. The depiction of the Product Warehouse to the players is displayed with the item number and the item description. The information provided is not available to players but is just presented here for ease of understanding and demonstration purposes only. Players will only know that a particular item is in the Product Warehouse but will not know the price and/or the quantity available. This Product Warehouse Catalogue is depicted here to present a clearer visualization of the potential items available to the gamers to win IF, in the unlikely case, no sponsors provide items for the Product Warehouse and they are all subsequently purchased by the invention's operators.

### DETAILED DESCRIPTION OF THE DRAWINGS AND THE PREFERRED EMBODIMENT

Description will now be given of the invention with reference to the attached FIGS. 1-11. It should be understood that these figures are exemplary in nature and in no way serve to limit the scope of the invention, as the invention will be defined by the claims, as interpreted by the Courts in an issued US Patent.

### I. Initial Bracket Set-Up

In the preferred embodiment of the present invention, there are a total of nine competitive rounds, and preferably there are a total of 184,755 players originally entered into the financial competition, all competing at least originally. For ease of explanation of the present invention, the preferred embodiment thereof will be presented. However, it is envisioned that other similar embodiments could be presented as well; many Games can be simultaneously run thereby increasing the total number of players within competitive Games and the numbers can be scaled up or down, as the Operators' desire. Players enter the game of the present invention preferably by paying an initial set-up and entry fee. Conventional software can be provided for gaining payment by the Operators in exchange for a download of the game or a User Number and Password for playing by each participant. The entry fee can be a one-time fee, a one-time fee coupled to monthly maintenance fees, or other financial arrangements can be made. For example, if players are charged just $10 per month for entry (and thus $90 a year to partake in the game of the present invention which preferably lasts a total of 9 months), they are entered into a pool with prizes potentially totaling over $16 million (for a tournament comprising the preferred number of 184,755 players), that averages $121.17 in value per merchandise winner. It is also envisioned that some players could enter without requiring them to pay a fee, and thus they might have different rules to play by and maybe different available prizes in the Warehouse from the full paying participants/players/competitors. However, in the case of some non-paying players, any actual paying player would take priority for entry into the game until the preferred total of 184,755 players is reached. While the preferred number of players in a single game is preferably set at 184,755, it is envisioned that multiple independent tournaments could run simultaneously or that the Bracket numbers could be scaled up or down, as desired. Maybe only 4 brackets would be run, maybe 10, it is the entire Operators' choice, at the initial set up.

At the beginning of the game each player is preferably staked to an equal amount of “virtual cash”—preferably one million virtual dollars. This will be shown on each competitor's account within the Game. It is expected that the participants will use that virtual cash to acquire positions in one or more common stocks, currencies, other securities, all based on what the Operators make available for purchase and trading within the Game. Preferably, likely, the competitors will use much of the virtual cash to acquire a portfolio of securities, preferably comprising between five and ten different stocks, from the game's pre-approved list of large capitalization/high volume stocks actively traded on the New York Stock Exchange. Some funds may be maintained in cash, too, of course, should the competitor desire to maintain the same for new and special opportunities or just to preserve some in their account. Just as a real account with a Broker maintains all of the investor's positions, the Game will do the same for the competitor's virtual holdings, indicating their cash position, positions held, date bought, quantity, product (usually common stock) bought, price purchased, sold, etc. In the universe of the Game, there is preferably a pre-set list of stocks available for players, mimicking, likely, the most traded stocks on the New York Stock Exchange, or those with the greatest market value, the most shares traded, etc. Here, too, the Operators can select at the beginning or during the game playing season, what is available to purchase, sell, and swap. Players are given the same amount of virtual cash to begin the game, at which time they can individually determine how to allocate their money for purchases. There is no requirement that players immediately buy stocks and spend all of their money, should they wish to watch the market initially before making any initial investments.

Whatever market products or common stocks are purchased becomes part of the player's portfolio, along with any remaining uninvested cash. A running summing is also present to show the competitor the then current amount or value of the account, even though there will, of course, just as in real life, be unrealized gains and losses. Nevertheless, the Game can provide valuations or “marks” based on last prices as the market closes or, if the market is open, based on the last recorded price of a real world trade or transaction. Alternatively, the Game can display the Bid and Ask for markets where trades can be consummated for every security and take a mid point between the Bid and the Ask to determine all securities' current market value. Of course, as the Game is expected to be principally comprised of companies with large capitalizations, frequently traded on the NYSE, it should be relatively easy and without much guesswork for a realistic value to be determined. A portfolio equates to a “position” in one or more securities. A player's position in an investment or common stock can be one of three things: neutral (not owned), positive (bought by the player) or negative (sold by the player). Each position within the portfolio is preferably assigned its basis (the value at which the security was originally either purchased or sold), and the basis can fluctuate as the portfolio is manipulated by the future purchases and sales for the same position during the game's investment periods. At any given time, a player's portfolio value is determined by the combination of the present value of all common stocks owned plus all unallocated cash.

Once all players are entered into the game and staked with the virtual cash, equally, they begin the first round, which is a Qualification (Placement) Round. This preferably takes place over a period of five weeks. The initial Qualification (Placement) Round is used to determine, based on profitability of each competitor, each player's placement in a bracket structure for the tournament. There are, as mentioned, preferably five brackets each with different numbers of participants. There is a Bracket I, II, III, IV and V (corresponding to named brackets: Premier, Elite, Masters, Champions, and Challengers) and then, bracket losers are assigned, to the Snake Pit, the lowest and in this example, the sixth Bracket in the tournament. Each bracket allows for competition within and among other competitors within the same bracket. Thus, a competitor doing well in the Qualification (Placement) Round, in comparison to the other competitors, might be ranked to be in the Premier Bracket. Going forward, to the extent he continues to play the Game, he will compete against others originally placed in the Premier Bracket. Yet, it will be appreciated that the Premier Bracket, according to the preferred embodiment of the present invention, is only assigned 729 competitors. Thus, in the Qualification (Placement) Round, the top 729 valued portfolios are assigned to Bracket I, the next 4,095 competitors ranked in the Qualification Round assigned to Bracket II, the Elite Bracket; 15,625 next ranked competitors from the Qualification (Placement) Round get assigned for future competition to Bracket III, the Masters Bracket, 46,656 to Bracket IV, the Champions Bracket and the balance of the original competitors or 117,649 people will be assigned to Bracket V, the Challengers Bracket.

During the Qualification (Placement) Round, players can begin managing their portfolios by buying and selling stocks and trading and/or swapping with other players, direct trades, swaps and even multiple party swaps, i.e., for example, Player A trades with Player B who trades common stock with C, who provides common stock and/or cash back to Player A (a so-called multi-player swap). While each player starts off with the same amount of virtual cash to make common stock purchases, some players may take risks by making moves with their portfolio—i.e., initial purchases and trades with other players—while others may prefer to hold onto their initial investments and wait to see market trends. Timing can be important but, of course, in this Game, aggressive play may be more important to success than in real life as the 5 week clock of the Qualification (Placement) Round is ticking and players are assigned to Brackets based on their performance at the end of the Round. Players can choose to manage their portfolios in any manner they desire. At the end of the Qualification (Placement) Round, all players are ranked based on the ending value of their portfolios—the combined total of common stock marked consistently for all competitors to a verifiable price, e.g., close of business value, plus unallocated cash—from player 1 having the best returns, having made the most profit (realized or unrealized) all the way down to player numbered 184,755.

### II. Assignment to Brackets I, II, III, IV and V

Once the Qualification (Placement) Round is complete, players are preferably assigned to the Bracket based on success in the Qualification (Placement) Round, and then compete in a series of preferably seven Elimination Rounds to determine the individual bracket winners and to ultimately determine the sole Ultimate Bracket Winner. As mentioned, those first 729 players doing the best in the Qualification (Placement) Round will be assigned to Bracket I, the ranked profitability of the next 4,096 competitors will be assigned to Bracket II, the next ranked profitability of 15,625 competitors will be assigned to Bracket III, the next 46,656 competitors assigned to Bracket IV and the final or poorest performing 117,649 portfolios and competitors assigned to Bracket V. As in a pyramid, the top Bracket, I, is the smallest and, in this illustrative parallel, has the fewest competitors and in each successive Bracket (II through V) competition increases exponentially in comparison to the top Bracket, I. Every competitor in every Bracket will compete against one another, in direct head to head competition, round by round, with the winner moving on to the next round with the bracket (7 elimination rounds are contemplated) and the bracket losers being eliminated from further group or bracket competition and being reassigned to the Snake Pit. Bracket I has three (1 v. 2) competitors competing each round; Bracket II, has a group of four (1 v. 3) players competing against one another each round; Bracket III has five (1 v. 4) players in a grouping; Bracket IV has six (1 v. 5) players and Bracket V has seven (1 v. 6) players in a group competing against one another, each round, with bracket winners moving on and bracket losers relegated to the Snake Pit. The competition is preferably set up so that the top competitor in each bracket is pitted against the worst competitor within that bracket, as determined by portfolio value, or, stated differently, in a manner similar to seeding in a tennis or basketball tournament, or, alternatively, within a Bracket, the groupings can be randomized. This may be done, specifically using the example of 184,755 players, as follows: in the top bracket that has 729 players and features head-to-head matchups of 3 players (1 vs. 2), the top 243 players are assigned to one of the 243 bracket matches as top seeds. Then, the bottom 486 are placed into one of the 243 competition brackets beginning with the 728^{th} and 729^{th} portfolio matching up with player currently with the number 1 portfolio value at the end of the qualification (Placement) Round. The remaining 242 competition brackets will be filled with players as per the previous example (i.e. the 726^{th} and 727^{th} players will match up with the player possessing the #2 portfolio value at the end of the qualification (Placement) Round, etc.) This progression will continue for each level of the pyramid, level (Bracket) 2 will have the top 1,024 players assigned to this bracket seeded in the 1,024 competition brackets matched against the bottom 3,072 of the 4,096 players assigned to this level of the Game. The next level (Bracket) 3 will see the top 3,125 players seeded in 3,125 competition brackets matched against the bottom 12,500 of the 15,625 players assigned to this level of the Game. The next level (Bracket) 4 will see the top 7,776 players seeded in 7,776 competition brackets matched against the bottom 38,880 of the 46,625 players assigned to this level of the Game. The next level (Bracket) 5 will see the top 16,807 players seeded in 16,807 competition brackets matched against the bottom 100,842 of the 117,649 players assigned to this level of the Game. Then as the Game progresses and the bracket winners advance to a new competition bracket matchup, the winner of the very top competition matchup on each level is paired with the winners of the lowest most competition brackets to create the next round of competitive matchups. This will continue until only one player from each level (Bracket) remains. Or this may be accomplished by sorting all of the portfolio values from first to worst within each bracket then assigning the highest portfolio value and the lowest portfolio value to an initial grouping. Then the next group is seeded with the next highest portfolio value and the next to the lowest portfolio value and so on until all of the initial groupings are seeded then each grouping is rounded out by the remaining portfolio values in the bracket until every grouping has an equal number of participants. After each round, the seedings can be readjusted as the NHL might do or maintained with the portfolio “owner” of the greatest profitability, realized or not, continuing to play within new groupings of other bracket winners and the bracket losers of a group relegated to the Snake Pit. At the end of the seven rounds, five bracket winners are determined, based upon profitability of their cash and common stock holdings. It is an aspect of the present invention to award those competitors with significant cash prizes. Those should be awarded based on relative profitability, not necessarily which bracket the competitor survives from. Cash is intended to be offered in differing amounts with the highest cash award (similar to a golf tournament) being preferably awarded to the highest of the five bracket winners in order of their portfolio returns at the conclusion of all qualifying and bracket competition elimination rounds. More preferably, the seven Elimination Rounds are comprised of three 5-week rounds, a single four-week round, and three 3-week rounds. Thus seven rounds of competition within Brackets are provided for a total, in this example, of 28 weeks of Bracket elimination competition, which when added to the Qualifying (Placement) Round (5 weeks) provides a total competition of 33 weeks. Weeks 34, 35 and 36 are devoted to the distribution of 157,042 (assuming that an aggregate of 184,750 players are in the Snake Pit) individual items of merchandise and services in the Product Warehouse to all players in the Snake Pit who have earned a minimum of 25,000 Warrior Points and the Finals Round (9), where the top 20 portfolios are pitted against the Ultimate Bracket Winner. The format, game or “Rules” of the Finals Round (9) are determined solely by the Ultimate Bracket Winner.

The Pyramidal Bracket set-up of the present invention preferably comprises five individual brackets (or levels) in which players compete against one another. In the preferred embodiment, the present invention allows for 184,755 competitive players to enter. All players compete in the Qualification (Placement) Round, and are then ranked based on the value of their stock portfolios at the conclusion of the Qualification (Placement) Round. Based on that ranking, the top 729 players are preferably placed into the top bracket, the next 4,096 players are preferably placed in the second bracket, the next 15,625 players are preferably placed in the third bracket, the next 46,656 players are preferably placed in the fourth bracket, and the remaining 117,649 players are preferably placed in the fifth bracket. Thus, the bracket set-up of the present invention places players into a competitive environment that rewards the most initially skilled players (as determined by profitability in realized and unrealized positions totaled with cash) with fewer competitors and the less relatively skilled players with more competitors in bracket competition. It is thus considered highly advantageous to be successful in the initial, preferably 5 week, Qualification (Placement) Round, as the number of competitors to be faced in each of the subsequent 7 Bracket Elimination Rounds could be reduced exponentially (for example, the fifth bracket is 161 times more competitive than the first bracket and 29 times more competitive than the 2^{nd} bracket, etc.). However, there is also no quantitative distinction between being the top player in the Qualification (Placement) Round or the 500^{th} player in the Qualification (Placement) Round, as the two players are entered into the same Bracket I, the Premier Bracket.

In the top, Premier or I Bracket, players compete in groups of three, with one winner from each group of three advancing to the next round. Thus, the 729 players compete in groups of three, with the 243 competitors showing the highest relative portfolio value in their group moving to the next round of competition. Those 243 winners of the group of 3 players then compete in new groups of three, with 81 winners moving on. This continues all the way down until there is only one winner from the top, Premier or I bracket. The competition is expected to span anywhere from 7 rounds up or 28 weeks, as designed by the Operator. Thus, there are a total of seven elimination rounds. For players in the top bracket, initially comprising of 729 players, each round will reduce competition down accordingly: 243 players, 81 players, 27 players, 9 players, 3 players, 1 player, respectively. At the conclusion of the seven rounds of competition among three players each round, there will be a single Premier or I Bracket winner for the top bracket.

In the second bracket, the 4,096 players compete in groups of 4, with one winner from each group of 4 advancing to the following round. This continues all the way down until, winners playing against other winners of portfolio value within the Bracket, losers eliminated and going into the Snake Pit competition, until there is only one winner from the second Elite or II bracket. Thus, there are a total of seven elimination rounds in the second bracket, comprising 4,096 players, going quickly after 7 rounds of competition to 1,024 players, to 256 players, to 64 players, to 16 players, and then to 4 players, 1 player, respectively. At the conclusion of the seven rounds or 28 weeks, there will be a single bracket winner for the second or Elite (II) bracket.

In the third bracket or Masters (III) Bracket, the 15,625 players originally assigned there, based on the Qualifying Round, compete in groups of 5, with one winner from each group of 5 advancing to the following round. This continues all the way down until there is only one winner from the third, III or Masters Bracket. Thus, there are a total of seven elimination rounds in the third bracket, each round providing group competition of a total of 15,625 players, 3,125 players, 625 players, 125 players, 25 players, and 5 players, respectively. Those five then compete for the last round and the competitor with the highest valued portfolio, comprised of common stocks, financial instruments and cash, is the Bracket III winner. At the conclusion of the seven rounds, there will be a single bracket winner for the third or Masters Bracket.

In the fourth bracket (IV) or Champions Bracket, the 46,656 players assigned there from the Qualifying Round will compete against the other five competitors, i.e., in groups of 6, with one winner from each group of 6 advancing to the following round. This continues all the way down until there is only one winner from the fourth (IV) or Champions bracket. Thus, there are a total of seven elimination rounds in the fourth bracket, each round comprising 46,656 players, 7,776 players, 1,296 players, 216 players, 36 players, and 6 players, 1 player, respectively. At the conclusion of the seven rounds, there will be a single bracket winner for the fourth (IV) or the Masters Bracket.

Finally, in the fifth or V Bracket (the so-called Challengers Bracket) the remaining 117,649 players from the Qualifying (Placement) Round, the bottom performing 117,649 players/competitors of the Qualifying (Placement) Round, compete in groups of 7, with one winner from each group of 7 advancing to the following round. This continues all the way down until there is only one winner from the fifth (V) or the Challengers Bracket. Thus, there are a total of seven elimination rounds in the fifth bracket, each round respectively comprising of 117,649 players, 16,807 players, 2,401 players, 343 players, 49 players, and 7 players, 1 player, respectively. At the conclusion of the seven rounds, there will be a single bracket winner for the fifth (V) or Challenger Bracket.

Through a 7 round competition over approximately seven months time, the game of the present invention narrows a field of 184,755 players to just 5 players. These are the five bracket winners, i.e., one winner from each bracket (I, II, III, IV and V; a/k/a Premier; Elite; Masters; Champions; and Challengers Brackets). Based on the structure of the pyramid bracket system of the present invention, it seems highly advantageous to increase the value or net gain of one's stock and cash combined portfolio in the Qualification (Placement) Round, to better one's position and decrease the number of competitors in the later rounds of competition. Clearly, competing against 728 competitors, albeit the top 728 competitors, provides a greater likelihood of winning a bracket than being placed in the II, III, IV, or V Bracket with so many more surviving competitors after the Qualifying (Placement) Round. Relatedly, in the elimination rounds of the Brackets, it seems preferable, for surviving and continuing on in the competition to play against others in later rounds, to compete in groups of 3 rather than in groups of 4, 5, 6 or 7. And, of course, groups of 4 are easier to survive than groups of 5, 6, or 7 and so on. Each bracket winner will continue on to face competition within the bracket, among other winners or survivors, all to face less competition (numerically) in each round, so the advantage is immediately provided to those with the greatest score in the Qualification (Placement) Round. Once a player is placed within a Bracket, there is preferably no means to jump to a different bracket. Thus, a player in the fifth (V or Challenger) bracket will have to compete in groups of 7 (1 v. 6) competitors for all seven rounds and against 117,648 other competitors whereas the competitor placed in Bracket I, for example, only competes against two (1 v. 2) other competitors for each round and, to survive and become the ultimate bracket winner, need only surpass in portfolio value 728 other competitors.

Throughout each round, players monitor their stock portfolios and are allowed to trade with other players, invest in new stocks, and sell stocks they currently own, even sell short on common stocks, all in hopes of generating the highest possible return on their portfolio. Two and multiple party/competitor swaps are also permissible, to Warrior Point advantage. Each player begins the Qualification (Placement) Round with an equal virtual investment amount, which they can individually use to purchase common stock, currencies, or other permitted fmancial products, with the purchases being based on the actual market value of those approved or available products, preferably common stock. The portfolios do not re-set throughout the game, and continue to aggregate in value (or decrease, depending upon underlying performance of the investment product) throughout the entirety of the game. Thus, players must attempt to determine a strategy to either win each round in the bracket tournament to survive to another round, or to compile while within the Snake Pit one of the top overall portfolio returns, even if eliminated in a round, in hopes of qualifying for the Final Round (9) (which will be discussed in more detail later).

In order to advance in each round of the competition, a player must have the best portfolio return of a head-to-head group (comprised of 3, 4, 5, 6 or 7 competitors) in which he/she is competing. However, an aspect of the invention contemplates that the players may not know the value of the portfolio returns of other players in their bracket or in the game as a whole. They may even be shielded from knowing the value of the portfolio of competitors within their group within a Bracket, then competing in a round. Preferably, the only information which players are provided is the value of the top ranked portfolio across all competitors, the value of another competitor, preferably the 20^{th} ranked portfolio, the player's own current standing or rank, and the value of the portfolios of the 10 players in front and 10 players behind that player. Thus, players must decide whether they prefer to attempt to win each round in the bracket tournament in hopes of being an Ultimate Bracket Winner and winning a monetary prize, or whether to prefer to play utilizing a longer term outlook and attempt to qualify for the Final Round (9), even if they risk being eliminated from the bracket tournament, by prevailing as a top 20 competitor emerging from the Snake Pit. Timing can be important to winning a round and/or a bracket and also in winning overall. For example, one creating a portfolio with relative little asset appreciation for all but the last week may be quickly eliminated from Bracket competition and earlier relegated to the Snake Pit of bracket losers, but if in that last week that portfolio booms (long-term outlook), beyond all others in the Snake Pit, that competitor may still win a grand cash prize, etc. especially if, at the end, the portfolio value is greater than even the 5 Ultimate Bracket Winners. Timing can be quite important in this game of financial acumen.

Once the Elimination Rounds are complete, and a winner from each bracket has been determined, the five bracket winners compete (1 v. 4) in round 8, which is 3-weeks in duration. The player with the best return of the five bracket winners is named the Ultimate Bracket Winner and receives a cash grand prize. Each subsequent finisher from 2^{nd} through fifth also receive cash prizes commensurate to the placing earned by that portfolio relative to the other four players' portfolio returns, from highest to lowest. The Ultimate Bracket Winner preferably who wins first place is awarded the largest available cash prize. Having won the 1^{st} place in the Bracket Tournament does not necessarily mean that the Ultimate Bracket Winner has earned the highest portfolio returns in the Game. Therefore the Ultimate Bracket Winner automatically moves on to the Finals Round (9), where he or she will preferably compete against 20 other players with the highest 20 portfolio returns in the Game at that time. These top 20 players will come predominately from the Snake Pit but it could very possibly include all or none of the other 4 Bracket winners. Regardless of their standing among the top 20 portfolio returns in the Game to date, the other 4 Bracket winners each win cash prizes, with the 2^{nd} place winner garnering the second most (after the Ultimate Bracket Winner) and the fifth place Bracket Winner garnering the least amount of cash, in other words not as much as the Ultimate Bracket Winner, the 2^{nd} place Bracket Winner, the 3^{rd} place Bracket Winner, etc. The Bracket Winners are awarded cash based on a) their survival from any Bracket, I, II, III, IV, or V and b) the value of their end portfolio, with no “credit” being given for which bracket the Winner survives from.

The Snake Pit's members and their portfolios and values are compared and with the Ultimate Bracket Winner (and the other Bracket Winners but based on Portfolio valuation, not the status of being a Bracket Winner), are ranked, The Ultimate Bracket Winner and the 20 highest Portfolios (including Bracket Winners and/or Snake Pit members) are placed into the Finals Round (9). Those 20 other players are made up of some of the other bracket winners, and/or of players who have been eliminated in the Elimination Rounds, but continued to build their portfolios in hopes of qualifying for the Finals Round (9). As will be discussed later, the game of the present invention provides a unique opportunity for even eliminated players to continue competing and be eligible for cash and/or prizes at the end of the game, even after having been eliminated in the bracket tournament, even if eliminated relatively early on in the Bracket Tournaments.

At the end of the Finals Round (9), a competition of 21 players for a limited period of time (3-weeks), a single, first-place game winner will be determined. Cash and/or material prizes are awarded to competitors in the Finals Round (9) based on three possible game options, which will also be discussed in detail later on. The total duration of the game—including the Qualification (Placement) Round, Elimination Rounds, and Finals Round—is preferably approximately nine months (36 weeks) in the aggregate. This provides a significant period of time for players to manage their portfolios and see actual change in the values of their stocks over time, giving them ample opportunity to make trades and buy and sell shares to compile the best portfolio and somewhat realistic, not due to luck or simple timing, returns.

Players in the game are preferably provided with an unrivaled and innovative online gaming experience which allows them to create and manage a realistic, stock portfolio, conduct unlimited trading with other players in the game, access research tools provided in the game for informed investment decisions, and the ability to see the portfolio returns of other players with whom they are directly competing. The game of the present invention preferably provides daily, portfolio-specific trading alerts to players updating them on information for securities in their portfolio, research alerts on specific companies, industries and/or analysts, and notifications of market movement.

Preferably, the research tools of the present invention are provided by individuals, such as business professionals or MBA candidates, who can provide reliable information on the common stocks or investment opportunities, which are subject to the game of the present invention. More preferably, the research provider(s) considered to be the most “effective” as determined by the players of the game will receive monthly cash incentives as well as receive a grand cash prize at the conclusion of the game for the single researcher receiving the most votes for effective research from the players of the game, thereby incentivizing accurate research information on the part of the researchers. Preferably, for research to earn a monthly cash award, a minimum number of players must have voted on research that month, for example 30,000 players. The author(s) with the highest rating for their research must have received an average rating of preferably 3.5 stars or just between informative and good tradable knowledge or as the operators of the invention may determine is beneficial to the quality of the gaming experience. If no author(s) achieves these minimums, the allotted cash award will, for that month, carry forward to the next month, increasing that amount available for award accordingly. This aggregation will continue until suitable research is offered to the gamers on a continuing basis such that enough gamers are “pleased” to respond favorably, thereby awarding the deserving author(s) with the aggregated cash awards. The operators of the invention neither endorse nor constrict the type of research offered. It is up to the players to accept or disregard what is presented. Acting as true measure for the value added qualities of information shared by aspiring professional researchers and/or MBA candidates who need to show work product as an effective aid in securing full-time employment, this player feedback element is a congruent proxy for the real world. The game of the present invention preferably provides up-to-date, accurate stock information relating to products listed on the New York Stock Exchange so that the Game is realistic and the competitors can consider the same or a similar strategy as they or another follow with real world funds.

### III. Snake Pit

While the game of the present invention allows for a large number of players, only a minimum number advance to the Finals Round (9). Preferably, only 21 players compete in the Finals Round (9). Even less—only 5 players—are bracket winners, and the substantial majority—more than 97.5% of all players entered in the tournament (See FIG. 8)—are eliminated within the first three elimination rounds in Bracket competition. Thus, the present invention also comprises a system for those early “bracket losing” players, having already been eliminated, with an incentive to continue to play in hopes of growing their portfolios to get back in the game—it is labeled the Snake Pit.

The base of the pyramid bracket structure (below the fifth (V or Challengers) Bracket, (See FIG. 1) is known as the “Snake Pit.” The Snake Pit is made up of all of the players who have lost in their Bracket completion in the Elimination Rounds. All players in the game, except for the five bracket winners, will eventually end up in the Snake Pit upon being eliminated, with most entering the Snake Pit after just the first two rounds of the elimination phase of the Game. The only players not to be captured in the Snake Pit are the five final round bracket winners. The Snake Pit is where the game's value as a conduit for the creation of customer advocates and brand messengers for sponsor companies is borne and honed, which will also be discussed later.

Once a player is eliminated from the Bracket rounds of the competition, meaning loses in any of the Elimination Rounds—and is relegated or placed in the Snake Pit, that player maintains an opportunity to be one of the top 20 portfolio finishers after all of the Elimination Rounds are concluded, and still qualify for the Game's Finals Round (9) of play. Players in the Snake Pit can continue to manage their portfolios, including making trades and swaps with any and all other players in the Game. Players in the Snake Pit are not in direct head-to-head competition with any set of players, but are competing with the field of “defeated” players to earn one of the 20 best portfolio returns in the Game to date in order to qualify for the Finals Round (9) in a match up with the Ultimate Bracket Winner. While in the Snake Pit, players are also given the opportunity to play for consumer merchandise, services, and game play-related advantages as well, such as line jumpers and line blockers (which will be discussed later).

While in the Snake Pit, players are preferably able to determine how far they are from a top 20 portfolio returns, know the 10 players with portfolio returns higher than theirs and the 10 players with portfolio returns lower than theirs, as well as the current returns of other players that he or she may be trading with, and daily trading logs to see where securities have been traded among players. This provides the competitive basis for players to maintain activity in the game, even after being eliminated, in hopes of winning a prize at the game's conclusion.

### IV. Gameplay

In the context of the game of the present invention, buying and selling is defined as acquiring and liquidating financial instruments, preferably common stock or equity securities, more preferably, those common stocks listed on a verifiable market exchange, most preferably, the NYSE, ASE, NASDAQ, etc. Those offer a wide range of available stocks and securities. In the game, players desiring to buy or sell securities can quickly and easily obtain from a variety of sources a current and accurate quote for a purchase, buy or sell, sell short for a round or partial lot. Those are generally at a market price. The player/competitor will indicate (see FIG. 8, for Example) the volume of shares the player wishes to buy or sell (FIG. 9) for that market or quoted amount. Alternatively, the player can complete the Buy Screen, FIG. 8, and submit the same to the Game's Operators who have their server computers directly linked to the market pricing offered by the NYSE, for the Game to make a complete buy at a fair price. These market prices or quotes offered by the Game's server computers will require quick thinking and action on the part of players as pricing based on the then current NYSE offered pricing can change rapidly. But, for the benefit of the Game and the players, it is considered somewhat preferred that the Game's offered Buy (or sell) pricing, derived from the NYSE directly, be quotes which will expire after only a predetermined number of seconds, (30-45). This allows Game Players some time to think and react, but, of course, it is not intended that the players “game the system or game” by watching the actual market, having a quote locked in by the servers and then, when the actual market moves to then execute a trade with the Game based on the actual movement of the market. That behavior and gaming advantage must be eliminated, of course. As such, if players in the Game have not created markets for a security to trade within, trades involving that security are (whether a buy or a sell) between the Game and a player and will be done at the mid-point between the quoted market bid price and the market offer price. For example, Pepsi has a NYSE market bid of 40½ and market offer of 41. The Game buys this security from any player at 40¾ (the mid-point between 40½ and 41) and sells this security at 40¾ to any player. If a player wants to sell a security to the Game and the NYSE market is (still using the Pepsi example) 40½ bid but, in the rare and unlikely case none are offered, the Game will sell up to 500 shares at 40½, if more than 500 shares are for sale, the next 500 are sold at ⅛ less the previous price or in this example 40⅜. If a player wants to buy a security from the Game and the NYSE market is (still using the Pepsi example) 41 ask (offered) but, in the rare and unlikely case none are bid, the Game will buy up to 500 shares at 41, if more than 500 shares are bid, the next 500 are bought at ⅛ more than the previous price or in this example 41⅛. In the rare and unlikely case a player either wants to sell or buy a security that does not have a complementing trading price listed on the NYSE, the player's market order (the desire to sell or buy at the market) will be converted to a (GTC) “good till canceled” order and the Game will constantly monitor the NYSE trading in order to identify the required complementing trading price necessary to consummate the “good till cancel” order. This may only take several seconds but could also, albeit highly unlikely, take several days to consummate. Thereby, if the player subsequently chooses to employ a different tactic in regards to the particular security, he/she may cancel the transaction before it has had a chance to execute. If Players do establish trading markets within the boundaries of the quoted market of the NYSE, (still using the Pepsi example), say the bid in the Game is 40½ but the ask (offer) is 40⅞ instead of the 41 as quoted on the NYSE, the Game will sell all securities for players who choose to trade with the Game at the bid of 40½ and will buy all securities for players who choose to trade with the Game at the ask of 41. This action would continue even if the Players establish a trading market, (still using the Pepsi example,) say the bid in the Game is now 40⅝ instead of 40½ but the ask (offer) is 40⅞ instead of the 41. The Game will sell all securities for players who choose to trade with the Game at the bid of 40½ and will buy all securities for players who choose to trade with the Game at the ask of 41. Players will quickly learn, as actual Wall Street traders and portfolio managers learn their first day on the job, that trading among other players offers by far the best opportunity to benefit their portfolios. Trading allows for negotiations and in some cases, if appropriate, collaboration, and in the more notorious circles within the Game, collusion.

This intensifies actions by players in the game by forcing players to make quick decisions regarding their portfolios as well as rewards the socially savvy among the Game players who may find manipulation (of players) as effective as diligent market analysis.

One aspect of the game of the present invention, which is not unlike real world Wall Street trading, is the ability to conduct direct portfolio transactions with other players of the game in addition to transactions with the market at reasonably current pricing. Therefore, in addition to common stock transactions where the pricing is based on that offered within the real market where players buy or sell shares of stock at the market price, players can also conduct transactions swap-like transactions amongst one another, creating a market within a market for shares and potentially creating a bidding war between players. The players can trade cash for securities, securities for cash, securities for securities, or combinations. Thus, a player looking to sell common stock, which it previously purchased through a more standard transaction with the Market price, may be able to get ⅛ or ¼ of a point higher per common stock purchase than the market value based on demand by other players. She/he can list their shares, by Ticker Symbol, the quantity, and his personal bid/ask and those shares will be “seen” on a screen of other players, via the server computers of the Game Operators, and the first to make the swap is the executing player (with the offering player, of course). Conversely, some players wishing to buy common stock may be able to pay ⅛ or ¼ of a point less than the then offered market quoted rate value (by the NYSE current market pricing) based on availability and stock outlook. Those buys and sells, directly between game participants are called Swaps herein. These Swaps can be tied into each player's individual game strategy, all trying to maximize their profitability from the original virtual investment. In addition, the Game contemplates that such Swaps can generate other advantages, beyond merely obtaining better values for the desired transactions (buy or sell) as, for example, the Players participating in such Swaps will also earn Warrior Points, which have value within the game for the purpose of achieving Prizes from the Product Warehouse of prizes. 25,000 Warrior Points are the minimum number that a Snake Pit player must have by the end of week 33 to qualify for a place in the queue or line to receive a selected item from the Product Warehouse. Thus, for example, if a player wishes to quickly win their bracket round and believes a common stock they own will decrease in value and another player who is playing for the longer term goal of being in the Finals Round (9) (or moving up in the Snake Pit groupings of competitors) may feel that upcoming seasonal aspects will enhance the prospects of that security in two months or so and therefore is desirous of owning it. Each player, for two separate reasons and motivations, arrive at a price equal to ¼ of a point per share lower than market value to facilitate a Swap—in which case both players are perceived to have “won” in the transaction—the seller rids his portfolio of the stock at a value close to market prior to a perceived slide in value, and the buyer pays a lower than market price for a common stock he believes will increase, over time, in value.

Trading between players in the game of the present invention is defined as the buying, selling, and/or swapping of securities or currencies and/or cash among two or more players. A Swap occurs when two or more players simultaneously buy and sell securities amongst one another. A simple intra-Game Trade can occur when one player sends stock to another player in exchange for cash, while an Intra-Game Swap occurs when a transaction between two players comprises equity common stocks being transferred or exchanged in both directions (and possibly including some cash as well, as the parties to the Swap decide to make the transaction). Any value differences between what is bought and sold in a Swap are reconciled as a cash value indication on the side of the Swap that is deficient in value, such that the Swap involves a perceived equal and then considered fair exchange of assets. Preferably, the Game will determine the cash differential (if any) that either part of the Swap must accommodate to facilitate a substantial and even exchange of assets although, of course, the players/competitors are truly in charge of that and if one is more “swaying” than the other in the Swap transaction, he or she will benefit and the other party may suffer, financially. But, that is the “market” place of laisser-faire capitalism. If there is a cash or perceived financial differential in the Game's perceived valuation of the proposed Swapping common stocks, the Server of the Game will indicate that on the Swap screen on the website of the game, and the cash amount will then, unless negotiated by one of the parties, agreed to by the other, be allotted to the portfolio exchanging a deficient value of securities to balance the transaction. If one player does not have enough cash to cover the balance of the transaction, the Game will either cancel the Swap, offer some other share(s) to add to the primary shares being considered, either party can cancel the swap, etc. Or, one party can reduce the number of shares or price offered for the Swap, etc. In this aspect of the Game, there is an incentive to perform a Swap transaction, as doing so will generate Warrior Points, which, as mentioned, are a component of the Game relating to obtaining prizes from the Warehouse. The players can accommodate the available cash differential, sell another security from the deficient portfolio to raise the necessary cash amount to consummate the original swap, or enter into a multi-party trade.

Multi-party trading is another aspect of the present invention. Here, a trade can involve the simultaneous sale and purchase of securities and/or cash amongst at least 3 players. Multi-party Swap or Transaction is typically used to facilitate a swap that cannot be done directly because of a deficit in free cash among the trading parties, the parties not wanting exactly what the other party is offering in the Swap, etc. Thus, a third and/or fourth or more participant is brought into the transaction and considered needed to facilitate the transaction. This, too, according to the Game generates Warrior Points for all.

For example, assume Player A wants to buy 500 shares of Revlon for $29½ and desires to enter into a Swap, instead of a simple and direct Buy from the Market in order to obtain a better purchase price AND to earn some Warrior Points. Of course, also assume that Player A also has some cash and Stock X. Suppose further that Player B wants to sell his 1,000 shares of P&G for $43½, and that that, too, is slightly more than he could obtain from a direct “Sell” in the Market (based on then-available pricing). And, of course, as mentioned because of the set-up and Rules of the Game, there is a benefit to doing so through a Swap or 3-Party Swap rather than a market transaction—and thus, B, too, wants to earn some Warrior Points. Well, if Player C is also desirous of earning Warrior Points (all players really benefit from earning Warrior Points) and if Player C owns, for example, Revlon shares, and believes he would lock in a profit and increase his potential profitability by selling his Revlon and to correspondingly “go long” with a desire to buy P & G, then the Parties, A, B and C, can enter into a Multi-Party Swap or Transaction, all parties benefiting and earning Warrior Points. C transfers his Revlon to A; A sells his X shares to B, who is willing to take them, with cash, and B sells his P & G to C, with cash being transferred between the parties to balance the trade and eliminate any deficits created by the agreed share prices. Here, all players gain what they want and earn Warrior Points, too.

As an example of a transaction proposed by a player in the Game to Buy stock, a player may use the format of FIG. 8 to request to Buy 5,000 shares of Macy*s stock at 18¾ at the current market or in a player-to-player Swap; with a Stop at 19¼; and the Order is Good For the rest of the Day. This means that that Player wishes to buy 5,000 shares of Macy*s stock at the market offer or among players in the Game and if there is a market offer of 18¾ or better (lower) but not more than 19¼ he will make the transaction. And, of course, his Offer to buy is Open for as long as it takes to buy or Swap 5,000 shares or until the market closes at the end of the day. As an example of a transaction proposed by a player in the game to sell stock (see FIG. 9) the player may offer to sell 1,000 shares of Macy*s stock at 19¼ which is at the market; or player-to-player; with a Limit of 18¾; GTC (good until cancelled). This means that this player wishes to sell 1,000 shares of Macy*s stock at the market bid or a Swap among players in the Game if the market bid is 19¼ or better (higher) but not less than 18¾, for as long as it takes to sell 1,000 shares or until the order is later cancelled. As an example of a simple, player to player or two person swap (see FIG. 10) Player One offers to buy 3,000 shares of Macy*s at $20 per share from Player Two in exchange for Player Two buying either 600 shares of Citi at 100 or 1,000 shares of J.P. Morgan at 60 from Player One. The Swap can be executed, with no exchange of cash and each of Player One and Player Two will also earn Warrior Points.

Market making in the Game occurs when a player offers one or more securities for sale at a Price (hereinafter, “the Ask”) at a specific price and substantially instantly buys (hereinafter, “the Bid”) the same securities at a specific different price. The Bid can be lower than, or equal to the Ask, depending on how aggressive the market maker is choosing to be with this particular transaction but, of course, it should be appreciated that for maximizing that Player's Portfolio's Return, it is highly desirable for the Ask to be executed at a higher price than the corresponding Bid purchase of the same securities, especially if the two sides of the transactions are made at or close to the same time. A market maker is the player who creates the highest Bid and the lowest Ask (offer) for the same security at the same time. Thus, not every transaction will have a market maker. In most markets within the Game, one player will have the market (highest) bid for a particular security and another player will have the market (lowest) ask (offer). In a Swap or multi-party Trade, the player who proposes the agreed-upon trade is deemed to be the market maker. Being the market maker of a trade earns that player the lion's share of Warrior Points to be distributed to the players who come together and consummate the trade. In fact, as a market maker, the more aggressive the player is (the smaller the spread is between the bid price and the ask price) the more Warrior Points will be awarded to all of the participants of that consummated transaction. This fact encourages all players to relish the opportunity to participate in aggressive trading and it checks players attempting to move conservatively among the trading elite within the Game. Conservative trades will rarely be consummated when more aggressive options are available for players to capitalize on, thereby keeping the Game market spreads fairly tight. Even that, however, can be negotiated and determined as between the players in the transaction. Small or half point spreads in the markets are common in the purchase and sale of securities. But, of course, if volume can increase by narrowing the spread and the Market Maker can continue to “Buy” at a price less than he can “Sell” the security, that Player can continue that strategy to great financial advantage. A market point spread represent the difference between the value per share of stock that the most aggressive (highest) bidder(s) are willing to pay for that stock or in a transaction (Swap) involving that stock and the value of that same stock that the most aggressive (lowest) seller(s) are willing to sell the same stock for or in a transaction (Swap) involving that stock at any given time. For example, a player may be willing to buy 500 shares of Pepsi at 40 and yet sell 1,000 shares at 40½. If no other player is willing to bid higher than 40 for Pepsi or willing to ask less than 40½ for Pepsi, then this is market for Pepsi at that given time. If, for example, another player surfaces that is willing to pay 40¼ for 250 shares of Pepsi, the market will shift from bid 500 shares of Pepsi at 40, offer 1,000 shares at 40½ to bid 40¼ for 250 shares of Pepsi offer 1,000 shares at 40½, thereby creating a tighter more aggressive market then previously. If players can complete both sides of this transaction, consistently, they can generate portfolio profits and highly coveted Warrior Points. This action by the player could be stated on one or more of the interactive windows of the Website as “Pepsi 40¼-½ 250×1,000.” Thus, in this example, the player offering Pepsi at 40½ is making a net profit on the sale of the shares he is willing to purchase for 40 by getting a ½ point higher back for each share than he is willing to pay himself. Markets that are set at spreads of less than half a point are considered aggressive as they encourage others to be a party to the “fair” transaction. For example, “Apple 33⅛-½ 1,500×100” is a mere ⅜ point spread in a market in which the player will pay $33⅛ for 1,500 shares of Apple, should someone be interested in selling the same (and earning Warrior Points) and, yet, he would agree to sell 100 shares of Apple at $33½. People with Apple shares in their virtual portfolio may be intrigued and those seeking to place Apple into their portfolio may be more interested in doing so directly from this Market Maker than buying at the Market. Warrior Points are an important aspect of the present invention and the preferred embodiment of the Game.

A locked market is one in which the market maker sets his bid and ask at the same price. As an example of a locked market transaction, “Virgin America 29-29 100×1,000” means a player is offering to buy 100 shares of Virgin America at $29 per share and, the same player is willing to sell 1,000 shares of the same Virgin America at $29 also. That Player will either close out his position (assuming that 1,000 shares is all that remains of that position), if someone offers to buy his 1000 shares or he will buy additionally, 100 shares of the stock at the same price of $29 per share, and end up owning 1100 shares.

If a player desires to buy or sell a stock in a market transaction, the game will preferably calculate a mid-market price (“mid” with respect to the current Bid and Ask, as reported by one or more preferred providers) based on the value of the stock for that given day, and award the player the mid-market price per share. This means that a player will either have to pay or be paid the median value of the highest ask and the lowest bid on that given day or, possibly, the Game will do similar calculations on a more real time basis. Additionally, the Game preferably only allows a player to conduct transactions of round lots, multiples of 100 shares of stock with the market and preferably with Swaps and Multi-Party Swaps, too, although other size trades can be within the scope of the Game. These features (the mid point between the Buy and the Ask for the end, beginning or middle of the day, or the mid point at any given time) are meant to reduce or prevent a player from gaming the Game and/or using the game to alter the actual market (by, for example, putting into the real market an unreasonable Bid or Ask) or vice versa by driving up or down the value of a stock in one to use to his benefit in the other. If, however, a player wishes to enter a transaction with another player, he will obtain the agreed-upon value of the shares in the trade at the moment of the trade.

A Short position can be created in the game, just as in real world market transactions, by a player when he agrees to sell shares of stock which he does not yet own and/or more of a stock than the player currently owns in his portfolio, hoping to buy it back at a lower price at a later time or, pursuant to the Game, being forced to buy back either when the Player's other positions reach a certain minimum level, or at a predetermined time (for example, end of the Tournament or a round, etc.). Players short sell stock when they believe that the common stock value will decrease over time. However, players, just as in real world market situations, are required to buy back the stock if they are short sellers, even if they incorrectly guess the market trend and the value of the stock actually increases. Just as in a common purchase or a Buy, even for a short sale of stock, players can indicate a Stop/Limit and limit the price for their purchase or required re-purchase, respectively. This is equivalent to setting a maximum dollar price the player will accept to Pay for the security offered for sale (for a straight or direct Buy) or the maximum that the Player will agree to Buy in a short sale context. In a short transaction, however, the Player wants to repurchase at the lowest possible price as that will (even if above his selling price) to maximize profit. Thus, just like in a Stop Limit Order for a purchase transaction, there is benefit to a Stop Limit Order for a short sale. If that price is or becomes the lowest price (the best price) for the buy back, then another player within the Game will sell that security, and the sell or offer will become the market offer price. Alternatively, the Limit of the Stop/Limit will indicate the highest possible price the security can get to before the player will want the Game to buy back the appropriate number of securities necessary to cover the short position. Typically, the Limit price will be higher than the Stop price. If the opposite is true during the Game, a warning will be indicated and provided to the Player, which the player can ignore at her/his choosing and possibly at his/her Game performance peril. Upon completion of a Day Order to short sell securities at a price at or above the Stop, the order is considered filled and the player's portfolio is reflected accordingly. If by the market's close, prices never equaled or rose above the Stop long enough to complete the order, it will be canceled. If a short sale is done as a GTC Order, it will remain in effect until it is filled by the Game, cancelled because of some other condition (e.g., time expired or insufficient available other assets to make the re-purchase) or canceled by the Player. Once the short position is created, the Game will immediately repurchase the necessary number securities at the Limit price when the mid-price between the market bid and the market offer is equal to or greater than the Limit price set by the player.

As an example of a short sale transaction in the Game, a player may decide to offer to sell short 2,500 shares of Macy*s at $19¼ per share at the market; player-to-player; a Limit at $19; and a Stop at $19¾; with the Order being of the GTC type. This means the player wishes to sell 2,500 shares of Macy*s that he doesn't own at the market bid among players in the Game if the market bid is $19¼ or better (higher) but not less than $19 for as long as it takes to sell 2,500 shares or until the order is cancelled. However, given that this is a short position, the player authorizes the game to buy back the shares to cover the position if the market mid point exceeds $19¾. This particular strategy protects the player's portfolio from losing no more than $1,250 (assumes the initial short was set at 19¼) if the short sale is a failure.

Throughout the first Qualification (Placement) Round (preferably the first 5 weeks of the Game) and bracket narrowing or Elimination Rounds (preferably the next 7 rounds), the Game allows for Players' portfolios to have open short positions, so long as those positions are covered by the end of the last of the Elimination Rounds (Round 8). Thus, if a player sells more shares than he owns, he must acquire the remaining shares to make up the difference of that which he previously agreed to originally sell by the end of the Tournament. If the player does not reconcile this discrepancy before the end of the Elimination Rounds (Round 8), the game will automatically reconcile that difference by forcing a purchase by that player of the shares at the then current market price. If the player does not have enough cash to cover the value of the shares to be repurchased, other positions—common shares of other equities, in a predetermined order as set by the Operators, in that Player's portfolio will be liquidated to cover the transaction.

Preferably, a transaction in the Game can be a Day Order or a GTC (Good 'Til Canceled) Order. In a Day order, the Game will attempt to Buy securities at a price equal to or less than the indicated Limit Price provided by the player (the lowest is the preferred price in a standard Buy, but the Player will indicate the highest price he will pay to Buy the common indicated stock) or in a Sell transaction, the Player can select the lowest price he will agree to Sell from the range of the game's market as that market's values ebb and flow throughout the day. Upon completion of the order to buy securities at a price at or below the Limit, the order is considered filled, and the transaction is reflected in the player's portfolio. If by the time the market closes for the day, the price for the desired stock never equaled or fell below the Limit provided by the player to complete the order, the transaction will be cancelled and no affect on the portfolio will be seen. The terminology and the execution and completion/cancellation of Trades, Swaps, whether in the actual Market, executed by the Game or by direct Swaps or indirect Multiple Party Swaps, is quite consistent and like that of the real market and terminology. Players in the real Stock Markets will be knowledgeable about the contemplated transactions in the Game.

Unlike in a Day Order, all GTC Order stock purchases from the market will remain in effect, day after day, until they are filled by the Game or canceled by the player (or they are timed out by the Rules/dates of the Game). These features of Day Orders and GTC Orders apply to transactions by a player with the market, or between multiple players. The same capabilities for Day Orders and GTC Orders apply to Sales, whether it is selling shares to the market at the current market price, or selling shares to another player based on the highest available bid. Also, these same capabilities for Day Orders and GTC Orders apply to Buys, whether it is buying shares from the market at the current market price, or buying shares from another player based on the lowest available offer.

Preferably, the Game of the present invention comprises an available Help? Section, accessible from any of the pages of the website for presenting further explanation, examples, indeed, an entire tutorial for answering questions that the players may have while involved in the Game, such as stock tips and gameplay strategy. Also, unique to the present invention is Tutorial Mode. The Tutorial Mode uses an animated icon that represents the Game's persona known as Ivgot Mordanu. Ivgot Mordanu is depicted as a ruthless hard-core “take-no-prisoners” “I win because you lose” personality. He will encourage aggressive play throughout and criticize more conservative play. His motivations change as players move through the Game and eventually wind up in the Snake Pit and begin playing to win a substantial gift item from the Product Warehouse. Now the avatar or persona will focus and incentivize players to accumulate the requisite minimum number of Warrior Points and to be savvy about putting together their Wish Lists and Product Rankings, consistently reminding them of different effective strategies that they may employ and to be aware of from other players. This character guides the player through every aspect of the Games operation as the player attempts to become acquainted with the ins and outs of the gameplay. Ivgot will suggest swap trades if asked as well as remind players to manage their temporary portfolio positions such as short sales and opportunistic purchases all of whose time has come for action of one kind or another. Players are capable of playing the entire game in tutorial mode if they choose to do so. The only apparent downside to doing so is that the extra steps that the tutorial will go through to consummate and/or initiate a transaction may cause these players to miss a time-sensitive opportunity or take advantage of a market anomaly. It is the suggestion of the operators of the game that most, if not all, of the players utilize the tutorial mode the first time that they play the game, regardless of the level of real world trading experience that any of them may possess. Thus, the present invention is also a very clever mechanism to teach and educate those without the financial experience to invest with real money in the real markets so that they gain knowledge, experience, etc. without having real money at risk. In addition, it is an aspect of the present invention that players can utilize the research tools of the Game and the game tutorial to help them make informed decisions regarding their real and/or virtual portfolio management.

### V. Warrior Points

Warrior Points are gameplay points, of which a minimum of 25,000 are required to qualify for merchandise and services being distributed at the end of the Game to at least 85% of the players who accumulate the minimum points, awarded to players for social participation, sponsor cooperation and aggressive and involved gameplay. Warrior Points are earned and accumulated by players simply for being active in the game of the present invention. The 85% win ratio assumes that every player in the Snake Pit will accumulate the requisite minimum number of Warrior Points to qualify for the Product Warehouse. If, for any reason, a number of Snake Pit players fail to accumulate the minimum number of Warrior Points, the win rate will go up accordingly, 157,042 items will be available for players with the requisite number of Warrior Points to choose from and if 157,042 or less Snake Pit players accumulate the minimum of 25,000 Warrior Points then the win rate will equal 100%. The accumulation of Warrior Points does not increase a Player's portfolio's profitability, but directly relate to a) making prizes available to the Players; b) maintaining interest in the game, even by those who have been eliminated by the head to head Bracket competitions, (for example, the 155,780 first arrivals to the Snake Pit at the end of Round 2 are all awarded 10,000 Warrior, increasing, by 60%, the probability of obtaining 25,000 Warrior Points by Week 33, no subsequent bracket losers are given Warrior Points upon their arrival to the Snake Pit), c) compelling and inspiring players to maintain “accurate” and updated Wish Lists and Product Rankings by being rewarded with Warrior Points for frequent trips to the Product Warehouse and product information searches related to specific items featured as game prizes and d) increase the likelihood that the Players will do more Trades and Swaps with each other and complete all forms of transactions, whether direct or through the market's pricing, thereby maintaining a high interest level in the Game, throughout the duration of the Qualifying (Placement) Round and all of the Elimination Bracket Rounds. Warrior Points earned are not forfeitable, under the Rules of the Game and provide the earners with several possible Game and Reward advantages.

Warrior Points are most readily earned by aggressive game play, which can include involved social and interpersonal activity, “shopping” (maintaining Wish List and Product Rankings) in the Product Warehouse, participating in sponsor and advertiser programs, research usage and feedback, simply being logged into the site for two hours within a 24 hour period, active portfolio management such as trading, buying, selling, and swapping securities, and/or active market making. Additional activities which earn players Warrior Points can include trading aggressively with other players, even viewing and/or visiting the virtual Product Warehouse, soliciting information from advertiser/sponsor companies, being receptive to requests, surveys, demands for personal information, etc. made by advertisers/sponsors, and most importantly, winning. Warrior Points can be earned while a player is in the Qualifying (Placement) Round, through the active Bracket Elimination or head to head competitive Rounds and even when a Player has been eliminated but is in the Snake Pit, i.e., after he has been eliminated from tournament play.
The currently preferred quickest and easiest way for players to earn Warrior Points is by advancing within the Bracket Tournament of each round. For example, at the conclusion of Round 2, 155,780 players will lose their first and only head to head Bracket competitions and will be relegated to the Snake Pit. For any player with a clear determination to win the cash grand prize, such an early exit from the tournament can be demoralizing, if not merely disheartening. The operators of the Game are quite aware that it is at this point in the Game that the highest probability of “player dropout” can occur. That is why the Game awards only these 1^{st} Elimination Round (Round 2) losers 10,000 Warrior Points upon their inauguration of the Snake Pit. This is the largest single Warrior Points award available during the gameplay portion of the game and gives these initial 155,780 players a 65% higher probability of reaching the requisite 25,000 Warrior Points. The remaining 28,975 players that advance to the Round 3 the Second Elimination Round (after the Qualifying (Placement) Round the Players are distributed into the Brackets, I, II, III, IV, and V; they compete against others in their Bracket for 5 weeks, in Groups of 3, 4, 5, 6 and 7; survivors of those first set of head to head competitions, by having the greatest profitability, move on to new head to head competitions, within the Brackets, but, in addition) the survivors ALSO preferably receive 1,500 Warrior Points for the current Game's use in the Prize Warehouse and an additional 2,500 Warrior Points that are effective only for the following year of a new Game, with a paid subscription. The Warrior Points earned from winning bracket competition are deposited in the players Experience Banks and can be “activated” by the player at the optimal time he/she feels it is time to assist in that player's overall gameplay strategy. As competition among the Brackets continue, the 4,659 players that advance to Round 4, the Third Elimination Round, preferably receive an additional 2,000 Warrior Points and an additional 2,000 Warrior Points that are effective only for the following year with a newly paid subscription. Then, similarly, as the Bracket head to head elimination proceeds, the 775 players that advance to the Fourth Elimination Round preferably receive an additional 2,500 Warrior Points and an additional 1,500 Warrior Points that are effective only for the following year with a paid subscription. As the Bracket Elimination narrowing of Players continues, narrowing the numbers of survivors and adding Players to the Snake Pit, all seeking to reach single survivors in each Bracket, the 135 players that advance to Round 6, the Fifth Elimination Round, preferably receive 3,000 Warrior Points and an additional 1,000 Warrior Points that are effective only for the following year with a paid subscription. The surviving 25 players of this fifth elimination round of the Brackets (3 in Group I; 4 in Group II; 5 in Group III; 6 in Group IV; and 7 in Group V, advance to 7^{th} Round, a Sixth Elimination Round, preferably receive 6,000 Warrior Points and an additional 500 Warrior Points that are effective only for the following year with a paid subscription. Of these 25 players, the 5 players that advance to Round 8 (Week 30) will receive 10,000 Warrior Points effective only next year with a paid subscription to the Game and one line jumper and one line blocker that are effective only next year, also with a paid subscription. The Warrior Points earned from winning bracket competition are deposited in the players Experience Banks and can be “activated” by the player at the optimal time he/she feels it is time to assist in that player's overall gameplay strategy. Thus, winning and advancing in the tournament is the fastest way to accumulate Warrior Points, which are used later in the game and also may provide advantages to a player for the following year's tournament.
Warrior Points are awarded for engaging in the Game. An annual maximum of 5,000 Warrior Points can be earned from logging on and engaging in the Game, as well as social and commercial activities on the Exchange Bracket website. Players must stay logged on a minimum of twenty minutes to start accruing points. A maximum of 20 Warrior points a day can be accumulated.
Warrior Points are also awarded for entering The Product Warehouse. An annual maximum of 7,500 Warrior Points can be earned from logging on and entering the Product Warehouse, creating (250 points) and maintaining (100 points) a “Wish List” and completing (750 points) and updating (250 points) the product preference rankings, engaging in advertiser/sponsor hosted activities on the Exchange Bracket website. Players must stay logged on a minimum of twenty minutes to start accruing points. A maximum of 50 Warrior points a day can be accumulated for just visiting The Product Warehouse.
Warrior Points are awarded for utilizing Research. An annual maximum of 1,500 Warrior Points can be earned from logging on and entering in the Research and Analytics portion of the website. Players enter in either the company name or symbols to see the lists of research available about a company. Research is listed in latest to oldest. Players can customize their searches to follow certain analysts, industries or most popular reports. Players can also receive emails or text alerts when new reports become available on the Exchange Bracket website. Players must stay logged on a minimum of twenty minutes to start accruing points. A maximum of 10 Warrior points a day can be accumulated.

However, after the first elimination round, 155,780 players—or 84% of the players entered in the tournament—are immediately sent to the Snake Pit. Thus, every player in the Snake Pit is preferably awarded 10,000 Warrior Points, all but assuring that each player will earn the requisite 25,000 points (points, it will be recalled, are available to be earned by creating or participating in direct Swaps or Trades) needed before the Final Round to enter the queue for the Product Warehouse so long as they remain active in the game. This is intended to keep players active and interested in the game even after being eliminated.

In an alternative embodiment of the present invention, at the conclusion of the Brackets, there will be 5 individual Bracket Winners, One Ultimate Bracket Winner (the Player with the highest profitability taken from all of the Brackets) and 20 Top Earning Players in the Game at that time and date, come predominately from the Snake Pit, i.e., losers in Bracket elimination who, however, have continued to play the Game and, with respect to the others relegated to the Snake Pit, have the top 20 largest profitability, as between the Qualifying (Placement) Round, the Bracket Elimination Rounds even including the last Bracket Elimination Round (Round 8). Those top 5 of the Brackets and those top 20 of the Snake Pit can be given an amount of Warrior Points, before the Game proceeds.

Warrior points are also awarded for executing trades and Swaps directly among players. The number of points is preferably determined by certain conditions. As an example, buying a common stock or security from a player who is offering securities for sale in the market awards 10 Warrior Points to each player; selling a security to a player who is bidding for securities to purchase in the market results in an award of 10 Warrior Points to each player; shorting a security earns 85 Warrior Points in addition to the 10 trading and, further, earns another 1 point per day that the short position is maintained, i.e., until the same is closed by the Player making the corresponding purchase of the shorted common stock. For cumulative positions of less than 500 shares, no additional Warrior Points are awarded until the short position equals or exceeds 500 securities. More Warrior Points can also be achieved by entering into multi-party trades. The specific amount of Warrior Points or basis for earning the same can preferably be determined at the start of the game each year (Placement) and, surely and preferably, the Rules announced and determined by the Organizers as the earning of the same is important to strategy, game play and the possibility to earn Prizes.

Warrior Points can also be awarded for and to the Players involved in market making. As an example, a Player making a market in a security with a ½ point spread can earn 15 points and 10 points to the other players involved in such a transaction. If the spread is greater than ½ point, 10 Warrior Points could be awarded to each player, while if the spread is less than ½ point (such as ⅜, ¼, or ⅛ point spreads) more points could be awarded to both players, with the market maker earning more and more points the smaller the spread becomes. In addition to the points based on the overall market value of a trade (a $100,000 trade will earn more Warrior Points to the Player than one transaction of $25,000) players can get Warrior Points based on the number of shares exchanged. For example, if the bid and the ask in the market are for at least 500 shares, the market maker can be awarded 45 Warrior Points while the other players are awarded 20 points each. The amount of Warrior Points can also increase for the size of a trade in correspondence with the spread of the trade (i.e., trade of over 500 shares with a spread under ½, results in more Warrior Points for all players). Additional points can also be awarded for trades in a locked market.

Warrior Points can also be awarded to players partaking in a Swap. For example, in a Swap of at least 500 shares, the Market Maker (the player who suggested the Swap) receives 50 Warrior Points and each party to the Swap (including the Market Maker) will receive 100 Warrior Points. For Swaps including less than 500 units of the common stock or securities, the Market Maker can receive 20 Warrior Points and each party to the Swap (including the Market Maker) can receive 30 Warrior Points.

Swap Reversals occur when players enter into a swap transaction with the sole intent to acquire Warrior Points. One party is the market maker for a swap entered into by another player and then, once consummated, the swap is reversed with the other player standing in the role of the market maker to acquire the disproportionate number of Warrior Points. Although swap reversals are not “illegal” they will not earn players the requisite Warrior Points if that reversal is consummated within a 24-hour period of the original swap. This will force players contemplating such a maneuver to assume some market risks which may prevent the wholesale corruption of this Warrior Point award process.

These are all examples of earning of Warrior Points, which relate to a) position in line for access to prizes in the Product Warehouse and to advantages vis a vis a new Game after the current game, (Warrior Points in excess of the 25,000 required for the Product Warehouse are accumulated in the player's Experience Bank, while Warrior Points accumulated for use in a particular episode of the Game that do not add up to 25,000 points at the end of the game are lost unless that player has Warrior Points in his/her Experience Bank that can aggregate his/her overall total to 25,000) b) either a reduced subscription price or other advantages allotted in a future episode of the game. However, the manner of earning Warrior Points and/or the number of Warrior Points allocated per activity listed above should not be interpreted as definitive limitations on the number of Warrior Points available or ways in which players can earn the same; they are merely representative.

In addition to trade activity, players can earn Warrior Points for engaging in the Game, including social and commercial activities on the game's website or a related website, e.g., Facebook, Twitter, etc. and for merely entering and reviewing the Product Warehouse, creating and maintaining a “Wish List,” completing and updating product preference rankings, and engaging in advertiser/sponsor hosted activities on the game's website, e.g., surveys, questionnaires, comments, etc. Upon logging into the game's website, players can also enter the Research and Analytics portion of the website where they can research companies whose common stocks are “in play” in the game. The results of the research generate possible Warrior Points for the creators and can be made available to the Players (free to subscribers; for purchase for non-subscribers) so that they may possibly make more informed portfolio management decisions. Players can preferably customize their searches for the Reports they seek to review, so as to follow certain analysts, industries, or most popular reports, and preferably can request alerts when new reports become available. Players can accumulate Warrior Points for conducting such research.

While the hope of all Players entering the game of the present invention is to become a bracket winner and specifically the Ultimate Bracket Winner, Warrior Points provide a component of the Game which allows players having been sent to the Snake Pit to still be very interested in the Game and to remain in contention in the game for valuable Prizes, even after they have been eliminated through Bracket competition. An additional goal of players relying on Warrior Points for winning prizes is to earn the right to seek and secure the most preferred of items in the Product Warehouse. Being “first” in line when the Product Warehouse opens is a combination of factors, overall profitability over the course of the Game until completion and accumulated Warrior Points. Several strategies can be employed to be among the first in line for the Product Warehouse, and accumulating Warrior Points is only one factor, albeit an important factor. Preferably, players require a minimum of 25,000 Warrior Points before being eligible to even be on line for access to the Product Warehouse and those players who have stored Warrior Points in their Experience Bank, may time the use of those points in order to achieve 25,000 points at the most opportune time for their particular game playing strategies. This encourages Game play by those in the Snake Pit (and also encourages those in the Snake Pit to remain interested and to continue to play the Game, resulting, of course, in those Players maintaining their subscription fees).

### VI. Product Warehouse (Prizes)

The Product Warehouse is only available to Players once they have been eliminated from the bracket tournament and sent or relegated to the Snake Pit. For the present Game, it should be clearly understood that one is either still in Bracket Competition or one is in the Snake Pit. The two are substantially mutually exclusive. If the player is the Ultimate Bracket Winner, that Player is not in the Snake Pit. However, the 5 Bracket Winners who then compete against one another for the last 3 weeks of direct competition, in a grouping of 5, will result in a single Ultimate Bracket Winner and the other 4 Bracket Winners, now losers, become relegated to the Snake Pit. However, all Players, including the Ultimate Bracket Winner and the other Players in the Snake Pit retain their profits and are ranked. It is possible, of course, that the Ultimate Bracket Winner actually is less profitable with respect to one or more Players in the Snake Pit but, surely, the Ultimate Bracket Winner has a greater profitability than the 4 other Bracket Winners which are in the final Group of 5 Players in the last Elimination Round (Round 8) of Bracket Elimination play.

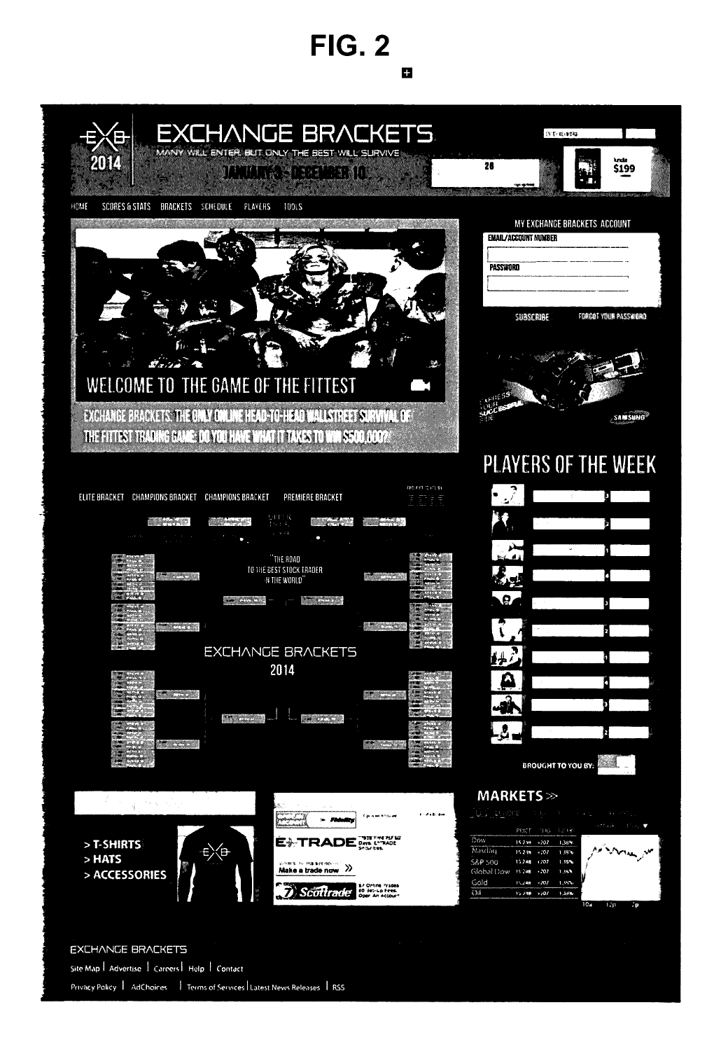

The Product Warehouse is filled with prizes/items (even cash equivalents can be an “item”) from sponsors and advertisers of the Game. These items are preferably known to players throughout the Qualification (Placement) and Elimination Rounds, and especially while the players are jockeying and fortifying their positions on the Product Warehouse line. The Product Warehouse is designed as an incentive for players to be continually active in the game, even after elimination by the Bracket method of competition, not only to accumulate Warrior Points but also to build the best portfolio possible. This ensures continued interest even after being eliminated from the Bracket component of the tournament. Additionally, the Product Warehouse provides the advertising companies the opportunity to market their products to individuals who could not necessarily afford such products. It is considered potentially great advertising and consumer awareness and thus advertisers and marketers are expected to willingly participate. Some will donate or contribute the prizes or money or a portion of their product for a prize, some may contribute prizes, money for prizes, a part of the prize and additional funds for the advertising opportunity. Preferably, at least a few of the available items have extraordinary monetary values (such as exotic and very expensive cars, yachts, jewelry, exotic vacations, etc.) while many items are of moderate value (such as flat screen televisions, laptops, cameras, electronics, jewelry, cell phones, kitchen appliances, video game consoles, tickets to sporting events, etc.) and some are of relative low value (such as back packs, Slinkys®, hats, t-shirts, etc.). The sponsoring companies for the Prizes are provided the opportunity to promote their product, generate “buzz” within and outside of the Game, use Social Media cross marketing opportunities, and, within the Game, to educate the players of the game—preferably the elite social class—on the products and/or services, the awareness level of the products and services of the providers, their visibility, etc. all to thereby increase the chance of word-of-mouth promotion by those players. Thus, for example, if a top prize in the Product Warehouse is a new Lamborghini, the players who seek, during the Game's weeks of competitions, to list that as the Player's #1 choice of Prizes available, will, necessarily, by virtue of being on a page of the top profitable winners, whether in gross amount, percentage of gain, Warrior Points, etc., see FIGS. 2, 4, 5, 6, 7, and 8-11, advertise to other Players which of the Prizes are available, being strived for, on one's Wish List, etc. providing advertising of the Products characteristics and/or new features, raising interest and awareness of the product and/or services.

Actual Distribution of available items from the Product Warehouse is determined by Players earning a place in “line” and then choosing among all of the remaining available items when it becomes that Player's turn to choose. So, clearly, the top Player in the Snake Pit, for example, from among those choosing a Prize and not playing for further money against the Ultimate Bracket Winner, will have his/her #1 Prize selection from the Wish List made based on the Wish List prioritization (and possibly the Product Rankings). It will obviously be available. The next to choose cannot choose that exact Prize (unless there are more than 1). But, the number two to select from the Warehouse is to be given his pick from among the remaining Prizes, i.e., after the first prize has been removed because of the selection by the first Player to choose.

To earn a place in “line” and thus the order of selection from the Warehouse, a Player in the Snake Pit must earn a minimum of a certain number of qualifying Warrior Points, in the preferred example, 25,000 Warrior Points. Once a player earns 25,000 Warrior Points and is thus eligible for the Product Warehouse queue or line, that player's order of selection is based on a variety of factors. At the time a player reaches 25,000 Warrior Points, that player is placed at the end of the line to the Product Warehouse directly behind the last person currently in line. Of course, portfolio returns are compared to every player in the line ahead of the Player. Once he encounter's a player with a higher portfolio return, he is placed in line just behind said player (with a lesser order of selection preference) with a greater financial portfolio return. In other words, a player entering the line will be placed ahead of every player currently on the line with lower portfolio returns than the incoming player at the time of his entry into the line. The players already in the line are those who have previously obtained 25,000 Warrior Points and have been placed in line they, through the same portfolio comparison process. The new player is then installed in the Product Warehouse line in a position directly behind the first player identified with the greater or equal portfolio return to the newly queued Player. Even if the new player has a portfolio return that is greater than the next 150,000 players “above” the player that he/she is being placed behind, it is of no consequence since the new player was effectively “blocked” from moving up by that other player's position on the line, and as a result of that Player's portfolio returns at the time he/she became eligible for placement in the queue, based on acquiring the minimum of 25,000 Warrior Points.

Players can continue to trade, buy, and sell securities in their portfolio in hopes of growing and/or maintaining their portfolio returns (and earning more Warrior Points for future Game's use in connection with subscription charges, extra Warrior Points (in excess of 25,000) are stored in what is called the Experience Bank) to block new players joining the line from jumping them on the line. No player can jump unless when they are eligible for the queue of the line and they have the greater portfolio return of those ahead of him at the time he is placed on the queue. While a player cannot advance in the line once already having been entered into the line, he can only attempt to prevent as many players as possible from jumping over him, primarily by profitability of portfolio and continued savvy game playing. Therefore, once placed in line, each player is incentivized to earn or harvest the highest portfolio returns possible to keep from being “jumped” by newly added Players who earn the 25,000 minimum Warrior Points. In the preferred embodiment of the invention, all Players are placed on the line once they earn the minimum Warrior Points but in an alternate embodiment, only those in the Snake Pit and acquiring 25,000 Warrior Points are eligible for placement on the line for the Warehouse prizes, it being understood that those still in Bracket Competition have incentive already to be part of and continue to follow the Game. Because of line jumping, (based on the timing of the placement and the Portfolio profitability) a subsequent in time player coming into the line can only jump another player's place in line if the jumper's portfolio value is greater than the player already in line. It is therefore advantageous to accumulate 25,000 Warrior Points as quickly as possible to enter the line and then continue to build your portfolio to block subsequent players from jumping over you. There may be an advantage to timing when you achieve the minimum Warrior Points for first placement on the line, too. By allowing their portfolio returns to optimize to within its highest point, some players can enter the queue and subsequently line jump tens of thousands of competitors before matching up with a player with a superior (or equal) portfolio return. This would be a renowned strategy for players who know that they are currently among the top 20 portfolios in the Game, yet an unlikely one that would be available given that achieving a portfolio with that type of performance almost certainly required tactics that earned the player a disproportionate number of Warrior Points and thereby earned for him/her the minimum number (25,000) long before the last weeks of the Game when employment of this strategy would be most effective. Players will need to develop their own strategy.

Some players will be more successful at improving their portfolios prior to entering the Product Warehouse line. If, at the time of entering the line, a player's portfolio is not as profitable as most of the players in line ahead of them, the player will be stuck towards the back of the line and will likely continually be jumped as more players achieve 25,000 Warrior Points throughout the game. If, on the other hand, a player has managed their portfolio well in the Qualifying (Placement) and Bracket Elimination competitive rounds and is able to jump many players in line at the time she/he achieves 25,000 Warrior Points, the player will likely rarely be jumped by new players as they subsequently achieve 25,000 Warrior Points, because other and older portfolios in line behind that player can act as a “blocker” or “buffer” as they themselves try to better their portfolio's value throughout the game. The closer towards the front of the line a player is, the more Players of “blocking” potential will be on the line behind them, which therefore makes it difficult for new players to usurp his position in line unless the new player has a far superior portfolio return at the time he acquires the 25,000 Warrior Points.

However, players can also earn “privileges” through game play that allow them to line jump and/or block players with superior portfolio returns. The easiest way to earn privileges throughout the course of the game is by winning rounds in the bracket tournament. Additionally, players can qualify for privileges randomly distributed throughout the game by the Operators, or by completing challenges presented in the game by the Operators or authorized Sponsors (Prize providers). Finally, privileges can be sold to advertisers who can then distribute the privileges to players they believe will most covet their product or based on other criteria, again, within the control of the Game Operators.

Two specific privileges in the game are Line Jumpers and Line Blockers. Line Jumpers allow, for one time only, a player to jump any player(s) in line ahead of him even though the player in line has a higher portfolio return than the player entering the line. Thus, earning a Line Jumper can be very valuable. It can be a single, double, triple, or more Line Jumper indicating the number of Higher Portfolio Value and number of Players the newly entering Player can jump above as he/she enters the line or queue.

Alternatively, Line Blockers allow players to protect their position in line for prize selection order within the Product Warehouse, even against players joining the line (with the newly acquired 25,000 Warrior Points) with higher portfolio returns who would, under normal circumstances, be able to jump that player's place in line. Like Line Jumpers, Line Blockers are a privilege, which is valid for one time use only. Line Blockers preferably trump Line Jumpers, and thus a player who, using a Line Jumper, attempts to jump a player possessing a Line Blocker, will be prevented from doing so, and will be placed in the line just below the blocking player. In that scenario, both the Line Blocker and the Line Jumper will be deemed to have been used and thus cannot be used again. Line Blockers also preferably have an additional feature, and specifically a virtual “switch” which can be activated by a player in the Product Warehouse line to only block jumping by players with superior portfolio returns, while allowing players possessing a Line Jumper to jump their place in line without triggering the Line Blocker. This may be a shrewd strategy for a player who is attempting to fortify his position in line by blocking players with truly superior portfolio returns and thereby creating a “dam” of high portfolio returns below his position in line to protect his position from subsequent jumpers entering with higher portfolio returns than his but not exceeding those on line behind or below his position.

At the End of Week 33 (Round 8) all players are in line who are entitled to be there, properly ordered with respect to Portfolio values, Line Blockers and Line Jumpers, etc. and the Bracket Elimination Rounds have concluded, the queue is set and players are able to access the Product Warehouse. Top of the line picks first from among the Prizes, next picks second, then third picks the third Prize from those still remaining, etc. Alternatively, a Wish List, see below, is used to automatically assign Prizes to the Players. During the duration of the game, players are unsure of their final landing spot in line while players continue to develop their portfolios and new players enter the Product Warehouse line, Portfolios being (“hopefully”) enhanced while in the Snake Pit and/or newly entering Players who have just lost head to head competition within a Bracket Competition. As a result, players can maintain a “Wish List” identifying the items in the Product Warehouse that they most covet. There are preferably 157,042 items in the Product Warehouse for 157,042 winners—or 85% of the original number of players in the Game—with the items broadly ranging in consumer products (exotic cars, boats, cameras, shopping sprees, etc.) and services (vacations, restaurants, spa days, etc.). Entities are expected to contribute to the Product Warehouse (or the Operators will purchase the same) for the purpose of marketing and advertising. The high winning percentage for players in the game is another unique and inventive aspect of the present inventive game. Prizes include physical items from the Product Warehouse (such as cars, vacations, electronics, and t-shirts), services (such as vacations, restaurant meals, spas, etc.) offered to the winners and cash prizes to the winners of the Brackets and the overall Final Round of the game.

Preferably, a Wish List can be assembled and will comprise a maximum number of items, and more preferably up to 20 items, which a player most covets. At least some of the items on the Wish List are those not only which a player most covets, but also items which the player has a high probability to obtain based on their portfolio valuation and their place in line. However, because of the uncertainty of a player's final position in line to the Product Warehouse until the conclusion of the Elimination Bracket Rounds (Week 33), players are incentivized (Warrior Points are awarded) to learn the details and specifications of most, if not all of the, items, to, at the very least, design a cogent and shrewd Wish List. Each player can create a “Wish List” with items that are most plausible for them to win based on their portfolio valuation, and rank those items based on interest level to the player. The formation of a Player's individual Wish List and thus learning about the features and characteristics of those items/services is important as Players can only receive one of them if they are in line to select that item/service and if the item/service is still available for selection from the Warehouse. Players must also rank each item available to be chosen from the Product Warehouse from most desirable to least desirable. When items are finally distributed to the players from the Product Warehouse, players are preferably awarded the available item that is highest on that player's Wish List at the time of their selection or highest in their Product Rankings if no items from their Wish List remain. Through the Product

Warehouse, advertisers and sponsors are given the opportunity to market their products and preferably target a demographic of customer advocates, product informers, and brand amplifiers to support the advertiser's product.

To create a Wish List, players must carefully weigh the benefits, characteristics, perceived value, etc. of the items in the Product Warehouse before applying a ranking and/or assigning it a coveted item label (First most desired; Second most desired; etc.) on the Wish List. Creating the Wish List/Product Rankings now becomes a critical undertaking. Each player must weigh carefully the items in the Product Warehouse before applying a ranking and/or assigning it a coveted item label on the Wish List. Shrewd and thoughtful rankings can assure a player of obtaining a coveted item, regardless of the line position that they ultimately earn to enter the Product Warehouse. This phenomenon is known as “a steal”. For example, assuming the Player accumulates 25,000 Warrior Points and participates in the final Prize selection process, upon a player's turn to choose from the Product Warehouse (determined by his Portfolio value). When a player's turn to choose from the Product Warehouse arrives, if the items available to him/her are not items found on that player's Wish List, the Game will locate the highest-ranking item listed on that player's Product Rankings. Because the Player's choice did not come from his/her Wish List, the Game will search among all players who have ranked that particular item as a top five preference on their Wish Lists. If no player has that item as a top five wish list choice, then the original player will receive his/her uncontested. Otherwise, the player(s) whose Wish List ranks that item the highest (i.e. 1^{st} over 2^{nd}, 2nd over 3^{rd}, 3rd over 4^{th}, 4th over 5^{th}) will have their portfolio returns compared with the player who did not have that item on his Wish List. The player with the highest portfolio return will receive the item. If that player is not the original player ho did not have that item on his/her Wish List, then that item was taken away from the player due to a steal by a lower queued player with a superior portfolio return. The original player will then receive the “highest ranked still available item” in the Product Warehouse based on his/her earlier Product Rankings.

This feature of the Game is popular with sponsors and advertisers of the Game because it rewards all players (regardless of their portfolio returns) to be well informed about every product sponsored in the Game whether it be, for example, an exotic vacation, a luxury sport car, a set of skis, a lawn mower, a set of professional-grade pots and pans, a jet ski, a year's supply of razor blades, an iPad®, or a child's bicycle and as such, shrewdly assign a top five ranking to a lifestyle item that will truly add value to that player's life while “stealing” it via jumping in front of the player who originally chose the item. Well-informed players share this knowledge with their social networks seeking support, advice for decisions to be made and/or offering support or advice to those within his social network who may be in the process of choosing a product or service.

Because the game of the present invention presents a great chance for each player to win in some way (6 of 7 players win an item of value either cash, service or merchandise) players are incentivized to be active in the game throughout its duration and try to generate the best return on their stock portfolios, even if eliminated from Bracket competition early on in the Game. In addition to line jumping when entering the line for the Product Warehouse, the ability to win prizes ranked highly in a player's Product Rankings based specifically on the value of his portfolio incentivizes players to continually monitor their portfolios and be active in the game, in hopes of qualifying for the Finals Round (9). This promotes competition throughout the duration of game and hopefully ensures that players are maintained, active and interested, even after losing in an Elimination Round. Of course, the Operators want the continued interest for satisfying advertisers, Prize promoters, and interest in the Game for the future, and for cash flow due to subscriptions.

As set forth above, Players will be selecting from the Product Warehouse based on their queue position, not necessarily based on their overall Portfolio value, although, of course, the two factors are related. At no time prior to the final dissemination of merchandise or services in the Product Warehouse are the queue positions of any player revealed or known by any source other than the Product Warehouse Database at the time of distribution of items. Because positions in the queue are so fluid through out the distribution period, even the game operators may not have an accurate list of the order of award dispersal until long after the items have been assigned. In fact, players, who will be notified of their awards as they are made, may have a more current list if they choose to broadcast to the other players their awards as they themselves are notified by the game.

### VI. Finals Round (9) Game

After all of the Bracket Elimination Rounds, and after all but the five bracket winners have earned their place in line for the Product Warehouse and, once within the Snake Pit, if time remains, they continue to grow their portfolios, the portfolios of the five bracket winners are compared to determine the Ultimate Bracket Winner. Alternatively, one more round of Elimination (Round 8) in head to head competition can be held for preferably 3 weeks, for example for the Bracket Winners. Once the Ultimate Bracket Winner is determined, the final portfolio returns are preferably calculated for all remaining players, including the 4 other bracket winners and the players in the Snake Pit. Final portfolio values for each Player are derived after the conclusion of the last Bracket Elimination Round (Round 8), during which time all securities traded, sold, or purchased during the trading period are valued. Mid-market values are set, and portfolios are valued. Short sales if not completed with appropriate Buy Backs are instituted. The portfolio returns are then preferably determined by comparing the basis of each common stock or security instrument within each Player's portfolio to their final prices as per the close of the appropriate exchange, for example, the New York Stock Exchange. The total profitability or value of the portfolio and thus the profit or return on each portfolio comprises the difference between the value of each stock at the conclusion of the game and its original basis price, plus the amount of unallocated cash in the portfolio, if present in the Player's virtual account.

Based on the portfolio valuations, the top 20 players are then determined, and are then given another chance to compete against the Ultimate Bracket Winner or finisher in a Finals Round (9) to determine the ultimate winner of the game and the recipient of the top cash grand prize. Based on the strategy and method of playing the game by the Players, it is possible that none of the other Bracket winners actually qualify for the Finals Round (9), since their portfolios were managed to win each individual round in the bracket, while players in the Snake Pit were still managing their portfolios, too, possibly, for example, with the long time periods and their returns in mind (for the end of a preferably 9-month game), with no concern for the immediate future value of the underlying common stocks to win the brackets at the shorter intervals.

Thus, the Finals Round (9) is set to consist of 21 Players, made up of the Ultimate Bracket Winner and the top twenty other portfolio returns (which may or may not include the other Bracket Winners). Alternatively, all of the Bracket Winners and 16 other of the top portfolios move on to the Finals Round (9) of competition. If there are statistical ties among the top twenty, the Ultimate Bracket Winner can choose among those players to participate in the Finals Round (9) or other tie breaker Rules can be referred to, e.g., Warrior Points, Experience Bank, latest day of entry into the Snake Pit, etc. Preferably, the Finals Round (9) is conducted over a three-week period of time.

Preferably, the distribution of cash awards to the Finals Round (9) Players is ultimately determined by a decision made by the Ultimate Bracket Winner. More preferably, the Ultimate Bracket Winner can choose from one of three Finals Round Game distributions of cash options. In the preferred embodiment of the present invention, there is $1 million in cash prizes to be awarded to the players in the Finals Round (9), allocated based on the nature of the Finals Round (9) of competition, as selected by the Ultimate Bracket Winner.

The first option is essentially a “winner takes all” competition. If the Ultimate Bracket Winner selects this form of Finals Round (9) competition, and also wins the Finals Round (9), he/she wins the entire Finals Round (9) cash prize, maybe $1,000,000 or more (determined by the Operators at the beginning of the Game). But, if the Ultimate Bracket Winner chooses this Winner Takes All form of Finals Round Competition and if the Ultimate Bracket Winner is not the Finals Round (9) Winner, he/she will win nothing, and the prizes are then distributed to the other 20 players and the type of distribution will then be determined solely by the player with the most Warrior Points. All finals players, including the Ultimate Bracket Winner, Warrior Points Totals will be considered for the opportunity to choose one of the following compensation scenarios for the winner of the Finals Round (9): 1) The 1^{st} place winner will receive the total distribution with none going to any of the other 20 players; 2) Each of the 20 players will receive an equal distribution of cash regardless of where they finished in the finals round; and 3) Each player will receive cash distributions based on a pre-determined basis, say, descending distributions (like in a Pro Golf tournament) from first Portfolio valuation to Last, (excluding any Prize being given to the Ultimate Bracket Winner regardless of where he/she ultimately finishes). Alternatively, proceeds may be distributed to the other Players in the Finals Round in equal distributions, i.e., if $1,000,000 is to be distributed, and then each of the twenty Other Players in the Final Round may receive, independent of the Portfolio values at the end of the Finals Round (9), $50,000. Or, alternatively, if the Ultimate Bracket Winner does not win the Finals Round (9), in the Winner Takes All competitive choice of cash distribution, those that have portfolios greater in value than his/her Portfolio, receive set-amounts or percentages of the Grand Prize and then, those who achieve Portfolio values lower than his/her will distribute the remainder equally among them. But, in the Winner Takes All form of the cash distribution for the Finals Round (9), if the Ultimate Bracket Winner does not win that round, he will not receive any distribution.

In the second option “Share the Wealth” (to be determined by the Ultimate Bracket Winner) the Players will compete in the Finals Round (9) and all Players will essentially share the available cash prizes among the Ultimate Bracket Winner and the others, with no Finals Round Participant going away “empty handed.” If the Ultimate Bracket Winner also wins the Finals Round (9), he/she wins a majority percentage of the cash prize, while the remaining amount is distributed to the other 20 players equally, regardless of where they finish in the final rankings. If the Ultimate Bracket Winner is not the Finals Round Winner, solely the finals player with the most Warrior Points will then determine the distribution. All finals players, including the Ultimate Bracket Winner, Warrior Points Totals will be considered for the opportunity to choose one of the following compensation scenarios for the winner of the Finals Round (9): 1) The 1^{st} place winner will receive a majority percentage of the cash prize, while the remaining amount is distributed to the other 20 players equally, regardless of where they finish in the final rankings; 2) Each of the 20 players will receive an equal distribution of cash regardless of where they finished in the Finals round; and 3) Each player will receive cash distributions based on pre-determined descending distributions (like in a Pro Golf tournament) and the player who ultimately wins the Finals Round or Ultimate Game Winner, who will receive half of the pot, will determine if the Ultimate Bracket Winner will be allowed to retain his winnings due him/her based on where they finish at the end of the Finals Round. In this embodiment of the invention, the Ultimate Game Winner can actually elect to deny the Ultimate Bracket Winner any earnings or Prizes. Then, the Ultimate Game Winner will receive the allotted top cash prize and any winnings due to Ultimate Bracket Winner will be equally divided among the rest of the Players and added to their fair and balanced distribution earned in the round (or other formulas for distribution can be used).

Finally, in the third option, called “Fair Share”, for the conclusion of the Game, selected again by the Ultimate Bracket Winner at the end of the Bracket elimination rounds, the players each get a percentage of the pot, with the percentage based on each player's rank after the Finals Round (9) (the same as a Pro Golf tournament's distribution of cash). If the Ultimate Bracket Winner also wins the Final Round he/she will receive the top percentage prize, while the remaining portion is distributed to the next 19 players in descending order based on their final portfolio values. The 21^{st} player, who finishes in last place among the 21 finalists, will receive nothing, no distribution of finals cash. If the Ultimate Bracket Winner is not the Finals Round Winner, he/she will still receive the percentage winnings based on his/her final portfolio rank. The player with the most Warrior Points will have no opportunity to alter the distribution of cash if this is the distribution option originally chosen by the Ultimate Bracket Winner.

Preferably, although the Ultimate Bracket Winner chooses which Final Game is to be played, the choice is considered confidential (except to the Game operators) until the conclusion of the Finals Round (9). The Ultimate Bracket Winner can share, although confidential, his/her choice with the other 20 players if he/she chooses. The Game operators will neither confirm nor deny what they are being told until the winners are announced and the player's final options are given. Alternatively, the other twenty players are informed of which of the three Final Game options he has chosen at the beginning of the Finals Round (9). If not, they play “blindly” while awaiting the conclusion of the game and only then will they be informed as to which form of cash distribution was chosen by the Ultimate Bracket Winner. Only after the Finals Round is over will the nature and consequences of the Game be disclosed to the other twenty players. Of course, the Operators will “lock” in the Game being played by the Ultimate Bracket Winner. The Ultimate Bracket Winner will be forced to communicate the same to the Operators before the Finals Round (9) begins but will have no obligation to share the option chosen, i.e., the truth with the other 20 players. The Ultimate Bracket Winner now has a powerful tool it can employ to win the Finals Round and its grand prize reward—deception. For example, if the Ultimate Bracket Winner can convince enough of the 20 finals players to “help him win” the Finals Round everyone will get some substantial amount of cash, in other words she/he convinces them the Game that they are playing is “Share The Wealth.” With enough of the 20 finals players working to undermine the other players who may be a threat to the Ultimate Bracket Winner, the Ultimate Bracket Winner wins the Finals Round. At the end of the round the game operators then announce that the Ultimate Bracket Winner is the sole winner of the grand cash prize because the game that he/she chose to play was “Winner Take All.” Ultimate Bracket Winner will have won $1,000,000.

### VII. Non-Subscribers

While the game of the present invention is preferably designed for subscribing players who pay a monthly fee to enter, it is also envisioned that non-subscribers (i.e., non-paying players) could enter, participate and even play in the competition, too. While game-play itself is transactionally free for subscribing players, non-subscribers are preferably required to pay fees for game functions such as execution of trades, swaps and multi-party swaps. Also, access to research will have a financial cost for non-subscribers while being “free of charge” to those paying the monthly subscription. Thus, it may be more likely that a non-subscriber will hold onto their initial portfolios in hopes of outperforming other players, as opposed to conducting trades.

There are other disadvantages to being a non-subscribing player. Non-subscribers are preferably not able to see the portfolio returns of other players in their brackets until the conclusion of each round, non-subscribers preferably do not know the portfolio returns of other players with whom they are trading, and non-subscribers preferably do not know where their portfolio returns rank in the hopes of being one of the top 20 profitable portfolios in the game for entry into the Finals Round (9). These are all features of the game, which are available to subscribing players at no additional cost (other than the monthly membership fee). Additionally, subscribers are preferably given preference over non-subscribers regarding the Product Warehouse line; specifically, subscribers are preferably given priority to select items from the Product Warehouse before non-subscribers, regardless of their respective places in line.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

### VIII. Advertisers and Sponsors

While the game of the present invention is preferably designed for the fantasy and enjoyment of the targeted demographic, what is also occurring is that the Game is herding together an elite demographic into an online social/gaming setting for prolonged periods of time each day. This prospect is extremely valuable to consumer products companies, advertisers and sponsors because the players are incentivized to be receptive and diligent researchers of the advertisers and sponsors products. The reason that this is an advantageous and unique quality is that conventional advertising has been becoming less and less effective.

“Interruption” or “push” marketing, which interrupts the potential customer while they are doing something of their preference, is the classification of contemporary advertisements as evidenced by television and radio. Despite marketers' best intentions, the fundamental relationship between consumers and ads is the act of ignoring (best case) and avoiding (worst case). Advertising firms know that they must learn to leverage digital and social media to get their clients to the targeted consumers on a more reliable basis. The challenge still remains getting people to pay a “reasonable” amount of attention to the message such that the “power of the idea” can take effect and lead to the desired or modified consumer behavior. “ . . . what makes social media so potent: its ability to amplify word-of-mouth effects. Yet, the vast majority of [company] executives have no idea how to harness social media's power.”—A 2012 McKinsey media study (by Roxane Divol, David Edelman, and Hugo Sarrazin). This has spelled the slow but sure demise of the “TV-Industrial complex” which means that creative advertising is less effective today because of clutter and advertising avoidance. Much of what we are told or read or watch, we simply do not remember. Its easier to remember and appreciate something . . . if you discuss it for two hours with your best friends. This invention is a social experience for the competitors; it is an object of conversation.

The time players spend in the Snake Pit and subsequently in the queue to enter the Product Warehouse are wrought with uncertainty and anxiety for all of the players. Players who are fortunate to be among the first to obtain the minimum of 25,000 Warrior Points must then contend with subsequent competitors who earn their minimum 25,000 Warrior points much later in the Game but who have higher portfolio returns and get to move ahead of them in line. Those same players who have entered the queue of the Product Warehouse late in the Game and have superior portfolio returns must then contend with line blocking competitors with inferior portfolio returns. Those players who have continued to work diligently on maintaining their portfolio returns have to also prepare for a certain percentage of players who will have inferior portfolio returns but will use line jumping to move past them in line. Yet when all of the Prizes are awarded, if one of the highly placed players has not shrewdly managed his her Wish Lists, a player “substantially down the line” will “steal” their awarded Prize in the 11^{th} hour. Because the human psyche craves predictability, neuroscience states that unpredictable scenarios like the one fostered in the present invention invoke the dopamine system of our brain for rewards as part of a semi-stressful response that we call desire. The present invention is literally driving our players “crazy with desire” for the products and services sponsored in the Product Warehouse. To deal effectively with these anxieties, every player must have the best available information to make the most informed decisions about their Wish Lists and Product Rankings. Also, it takes 36 weeks to play the Game, players will have every opportunity to invoke the opinions and advise of family, friends, neighbors and/or co-workers creating conversation and the exchange of information and experiences about the products and services offered in the Product Warehouse. Because of an 85% (6 of 7) win ratio, every player will have a strong sense of certain victory (of some sort) and as such, it will elicit a rabid incentive to pursue relevant product information about items featured in our Product Warehouse. Thus, the opportunity for our sponsor/advertisers is not just to laser target a demographic not only willing or receptive to the product message, but to also recruit and “train” an eager group of customer advocates and brand amplifiers manufactured by our invention.

This invention promotes customer advocacy among the game's players by giving them a trigger (create and maintain the Wish List and Product Rankings), providing product information that gives these advocates “social currency” that they share with their social networks. This culminates in those who originally hear from the initial advocate subsequently also sharing this newly acquired “social currency” with their secondary social networks and then the tertiary social networks and so on. Therefore the effectiveness of the invention as a cost-effective alternative to contemporary advertising must be emphasized. An example of how this would work mathematically would be if the average player (184,750 players) in the Snake Pit advocates to 5 friends about a product or service in the Product Warehouse and each of the 5 advocate to 3 others and if each of the 3 advocate to an additional 2 persons, total to be reached by the message would be 113 million individuals.

What is claimed:

1. A computer based, virtual financial game comprised of a multiple of Players, each Player staked to a virtual initial Portfolio position, wherein the Players can execute, based on actual financial securities in a real world Market, including common shares, buys, sells and selling short, further comprising Players making direct Swaps of said financial securities and Multi-Party trades of the same, wherein the value of the Portfolios is marked to the actual values of the securities in the real Market, further comprising a series of elimination rounds comprised of a first Qualifying (Placement) Round of head to head competition to determine ranking of the Players based on their Portfolio values at the end of a period of time, one or more elimination rounds configured in a Bracket-like competition for a second period of time, and a third competition among the Top Portfolios of the Players surviving the Bracket-like elimination rounds and a preset number of the other Portfolios.

2. A computer based, virtual financial game as claimed in claim 1 wherein said Multiple of Players is a multiple of 184,755 and said Bracket-like eliminations are arranged for competitions of 3, 4, 5, 6 and 7 Players with one Player surviving each Bracket to play against surviving winners until a single winner is derived.

3. A computer based, virtual financial game as claimed in claim 1 wherein a smaller number of Players play head to head in comparison to a greater number of players in another bracket, and said Bracket-like elimination rounds are seeded from said Qualifying (Placement) Round such that the higher Portfolio values at the end of said period of time are placed into a Bracket-like elimination round with fewer Players and fewer head to head Players in direct competition in comparison to lower Portfolio values of other Players.

4. A computer based, virtual financial game as claimed in claim 1 wherein said Players can earn Points by executing direct Swaps and multi-party Trades and/or Market Making and said Points are accrued during the Game towards Prizes.

5. A computer based, virtual financial game as claimed in claim 4 wherein said Points can be accumulated to a minimum number in order to have access to Prizes based and Players are entitled to a Prize based on their Portfolio Value in comparison to Portfolio Values of other Players.

6. A computer based, virtual financial game as claimed in claim 4 wherein a Player with a Portfolio Value and having a predetermined number of Points is placed in a queue for Prizes and said queue is based upon the value at the time of reaching said predetermined number of Points such that a new Player to the queue is raised up in the queue to the highest level but beneath that of a Player with a greater Portfolio Value already on queue.

7. A computer based, virtual financial game as claimed in claim 6 wherein the Game also provides the Jumping right for a Player, which allows the same, when entering the queue to be placed on the queue above that of a Player already on queue with a greater Portfolio Value.

8. A computer based, virtual financial game as claimed in claim 6 wherein the Game also provides the ability to obtain the right to Block new Players entering the queue from going to their otherwise rightful location in the queue even though the new Player entering the queue has a Portfolio Value greater than the Portfolio Value of the Player holding the right to Block.

9. A computer based, virtual financial game as claimed in claim 8, wherein a right to Block new Players from taking their rightful location in the queue takes precedence over a Player with a Jumping right.

10. A computer based, virtual financial game as claimed in claims 7 and 8 wherein said right of Blocking and Jumping is only once usefully used by a Player when the Player reaches the predetermined minimum of Points and is being placed on the queue for Prizes.

11. A computer based, virtual financial game as claimed in claim 6 wherein said right of a Player is to maintain a predetermined number of items on a Wish List and a Product Rankings list among all of the merchandise prizes.

12. A computer based, virtual financial game as claimed in claim 11 wherein said players in the queue for Prizes are awarded their Prizes based on the availability of items listed on the Wish List.

13. A computer based, virtual financial game as claimed in claim 11 wherein said right of a Player to maintain a top limited number of items on said Wish List and to “steal” a prize being awarded to a player ahead in line who is choosing from his Product Rankings list of all of the merchandise prizes even when that item being awarded is on the Player's top five Wish List.

14. A computer based, virtual financial game as claimed in claim 1 wherein the Bracket-like Elimination Rounds are greater in duration than the Qualifying (Placement) Round.

15. A computer based, virtual financial game as claimed in claim 1 wherein the Game duration is 9-months, 36 weeks comprised of 9 rounds of competition.

16. A computer based, virtual financial game as claimed in claim 15 wherein the pace of the Game accelerates over the duration namely, the 1^{st} four rounds are 5 weeks, the fifth round is four week, and the last four rounds are each 3-weeks.

17. A computer based, virtual financial game as claimed in claim 1 wherein the Players each with the greatest Portfolio values at the end of the Bracket-like elimination compete against one another for a third period of time and a single Ultimate Bracket Winner is declared.

18. A computer based, virtual financial game as claimed in claim 1 wherein said Ultimate Bracket Winner earns a cash prize.

19. A computer based, virtual financial game as claimed in claim 1 wherein said Ultimate Bracket Winner selects the format of a Finals Round between him/her-self and some predetermined number of Players with the end of the elimination Rounds highest Portfolio values.

20. A computer based, virtual financial game as claimed in claim 14 wherein said predetermined number of Players includes those Players, which have previously been eliminated from Bracket-like competition.

21. A computer based, virtual financial game as claimed in claim 15 wherein said Ultimate Bracket Winner can choose a Finals Round format for distribution of Cash Prizes from among: “Winner takes all”—If the Ultimate Bracket Winner wins the Finals Round he/she is the sole cash winner; “Share the Wealth”—Players shares equally; or “Fair Share”—Cash Prizes are distributed dependent upon Portfolio value.

22. A computer based, virtual financial game as claimed in claim 21 wherein said Ultimate Bracket Winner choice of Finals Round format for distribution of Cash Prizes is confidential and not revealed to the other players officially until after the Game has been played.

23. A computer based, virtual financial game as claimed in claim 22 wherein if said Ultimate Bracket Winner does not win said selected Finals Round format for distribution of Cash Prizes, the player participating in the Finals Round with the most Warrior Points determines the distribution of cash to be awarded among the Finals Round players.

24. A computer based, virtual financial game as claimed in claim 1 wherein at least some Players pay an entry fee for playing the same over the Internet.

25. A computer based, virtual financial game as claimed in claim 17 wherein an option is provided for not paying a fee for playing the same over the Internet but that paying Players have an advantage in earning Points as they play the Game.

26. A computer based, virtual financial game as claimed in claim 1 wherein the Prizes of the Game are donated in exchange for advertisement and exposure.

27. A computer based, virtual financial game as claimed in claim 1 wherein a multiple of exotic prizes in addition to cash are available to the Players of the Game.
